(19) United States
(12) Patent Application Publication
(10) Pub. No.: US 2025/0189906 A1
(43) Pub. Date: Jun. 12, 2025

(54) IMAGE FORMING APPARATUS AND IMAGE FORMING SYSTEM

(71) Applicant: CANON KABUSHIKI KAISHA, Tokyo (JP)

(72) Inventors: MASAHIRO SUETSUGU, Kanagawa (JP); SHINICHI NISHIDA, Kanagawa (JP)

(21) Appl. No.: 18/972,099

(22) Filed: Dec. 6, 2024

(30) Foreign Application Priority Data
Dec. 8, 2023 (JP) 2023-207553

(51) Int. Cl. G03G 15/08; G03G 15/00; G03G 21/18

(52) U.S. Cl. CPC G03G 15/0862; G03G 15/0874; G03G 15/0886; G03G 15/556; G03G 21/1814; G03G 2215/0682; G03G 2215/0692

(57) ABSTRACT

When a remaining toner amount of an accommodating portion corresponding to an output value before first toner supply is a first remaining toner amount, a remaining toner amount of the accommodating portion based on a toner filling amount in the accommodating portion in an unused state and image information of an image printed from a time of the unused state to a predetermined timing is a second remaining toner amount, a condition that the first remaining toner amount is larger than the second remaining toner amount is a first condition, and a condition that the first remaining toner amount is smaller than the second remaining toner amount is a second condition, the controller sets a discrimination threshold so that the toner container used for the first toner supply is easily discriminated as the first toner container in the first condition is than in the second condition.

### FIELD OF THE INVENTION AND RELATED ART

The present invention relates to an image forming apparatus, for example, an image forming apparatus for forming an image on a recording material and an image forming system including the image forming apparatus.

In general, an image forming apparatus of an electrophotographic type forms an image by transferring a toner image, formed on a surface of a photosensitive drum, onto a transfer material as a transfer medium. Further, as a developer supplying type, for example, a process cartridge type or a toner container supplying (replenishing) type has been known. The process cartridge type is a type in which the photosensitive drum and a developing (developer) container are integrally assembled as a process cartridge in which the process cartridge is exchanged with a new one when a developer runs out. On the other hand, the toner container supplying type is a type in which when toner runs out, toner is supplied (replenished) from a toner container, such as a toner pack or a toner bottle, to a developing container.

Conventionally, an image forming apparatus including a remaining toner amount sensor for estimating a remaining toner amount of a developing container by a light receiving time of detection light, emitted from a light emitting portion and passed through an inside of the developing container, received by a light receiving portion has been proposed (for example, see Japanese Laid-Open Patent Application No. 2020-154300). The developing container is provided with a stirring member for stirring the toner, and the light receiving time of the detection light by the light receiving portion becomes longer with a smaller remaining toner amount of the toner in the developing container. Further, information on the remaining toner amount detected is displayed on a remaining toner amount panel provided on a surface of the image forming apparatus. The remaining toner amount panel is a panel member including three scales, and each of the scales is lighted or extinguished depending on a remaining toner amount, so that the remaining toner amount panel notifies a user of the remaining toner amount.

### SUMMARY OF THE INVENTION

According to an aspect of the present invention, there is provided an image forming apparatus to which a plurality of toner containers including a first toner container in which toner in a first toner amount is accommodated and a second toner container in which toner in a second toner amount is accommodated are mountable, the image forming apparatus comprising: a mounting portion to which one toner container of the plurality of toner containers is mountable; an accommodating portion configured to accommodate the toner supplied from the one toner container mounted to the mounting portion; a detecting portion configured to output an output value depending on a remaining toner amount of the toner accommodated in the accommodating portion; and a controller, wherein the controller discriminates whether the one toner container used for first toner supply, from an unused state of the accommodating portion, which is toner supply from the one toner container to the accommodating portion is the first container or the second container by comparison between a threshold and the output value immediately after the first toner supply is made, and wherein in a case where the remaining toner amount of the accommodating portion corresponding to the output value in a predetermined timing before the first toner supply is made is a first remaining toner amount, the remaining toner amount of the accommodating portion based on a toner filling amount of the toner filled in the accommodating portion in the unused state and image information of an image printed from a time of the unused state to the predetermined timing is a second remaining toner amount, a condition in which the first remaining toner amount is larger than the second remaining toner amount is a first condition, and a condition in which the first remaining toner amount is smaller than the second remaining toner amount is a second condition, the controller sets the threshold so that the one toner container used for the first toner supply is easily discriminated as that the one toner container is the first toner container in a case where the first condition is satisfied than in a case where the second condition is satisfied.

Further features of the present invention will become apparent from the following description of exemplary embodiments with reference to the attached drawings.

### BRIEF DESCRIPTION OF THE DRAWINGS

FIG. 1 is a perspective view showing an image forming apparatus according to an embodiment.

FIG. 2 is a schematic sectional view of the image forming apparatus of the embodiment.

Part (a) of FIG. 3 is a perspective view showing the image forming apparatus in a state in which a discharge tray in the embodiment is in a closed position, and part (b) of FIG. 3 is a perspective view showing the image forming apparatus in a state in which the discharge tray in the embodiment is in an open position.

FIG. 4 is a sectional view of a developing container of the image forming apparatus of the embodiment.

FIG. 5 is a top (plan) view of a supplying portion, a scanner unit, and a photosensitive drum in the embodiment as viewed from above.

FIG. 6 is a perspective view of the developing container in the embodiment.

Part (a) of FIG. 7 is a perspective view showing a state in which a lever is positioned in an operation position in the embodiment, part (b) of FIG. 7 is a perspective view showing a state in which the lever is positioned in a supply position in the embodiment, and part (c) of FIG. 7 is a perspective view showing a state in which the lever is positioned in the operation position in the embodiment as viewed from an observation point different from those in parts (a) and (b) of FIG. 7.

Part (a) of FIG. 8 is an exploded perspective view of the supplying portion in the embodiment, and part (b) of FIG. 8 is another exploded perspective view of the supplying portion in the embodiment.

Part (a) of FIG. 9 is a schematic view showing a state of a switch when the lever in the embodiment is in the operation position, and part (b) of FIG. 9 is a schematic view showing a state of the switch when the lever in the embodiment is in the supplying position.

Parts (a) and (b) of FIG. 10 are schematic views each showing a supply pack in the embodiment.

Parts (a) to (c) of FIG. 11 are exploded perspective views each showing the supply pack in the embodiment.

Parts (a) and (b) of FIG. 12 are perspective view each showing state

immediately before the supply pack in the embodiment is mounted to the supplying portion.

FIG. 13 is a schematic view showing a state in which a user loosens (deforms) the supply pack in the embodiment.

FIG. 14 is a schematic view showing a position of a grip portion when a lever in the embodiment is in an operation position and a supply position.

Part (a) of FIG. 15 is a block diagram showing a hardware constitution of a controller in the embodiment, and part (b) of FIG. 15 is a block diagram showing a software constitution of the controller in the embodiment.

Parts (a) to (d) of FIG. 16 are perspective views each showing that a display position in the embodiment indicates an associated level.

FIG. 17 is a schematic view showing a relationship between a threshold for switching remaining toner amount display and a toner amount in the embodiment.

Parts (a) and (b) of FIG. 18 are schematic views each showing an example of supply mode display in the display portion in the embodiment.

FIG. 19 is a flowchart showing control of the display portion when a supplying operation is performed in the embodiment.

FIG. 20 is a graph showing a relationship between a printed sheet number and an aggregation degree of toner in the embodiment.

FIG. 21 is a graph showing a relationship between the aggregation degree of the toner in an accommodating portion before supply and a pulse count after the supply in the embodiment.

FIG. 22 is a graph showing that an optical remaining amount detection preceding degree quantitatively indicates the aggregation degree of the toner in the embodiment.

### DESCRIPTION OF THE EMBODIMENTS

In the following, exemplary embodiments for carrying out the present invention will be described while making reference to the drawings. However, dimensions, materials, shapes, a relative arrangement, and the like of constituent elements described in the following embodiments should be appropriately changed depending on constitutions and various conditions of apparatuses to which the present invention is applied, and, the scope of the present invention is not intended to be limited to the following embodiments.

### Embodiment

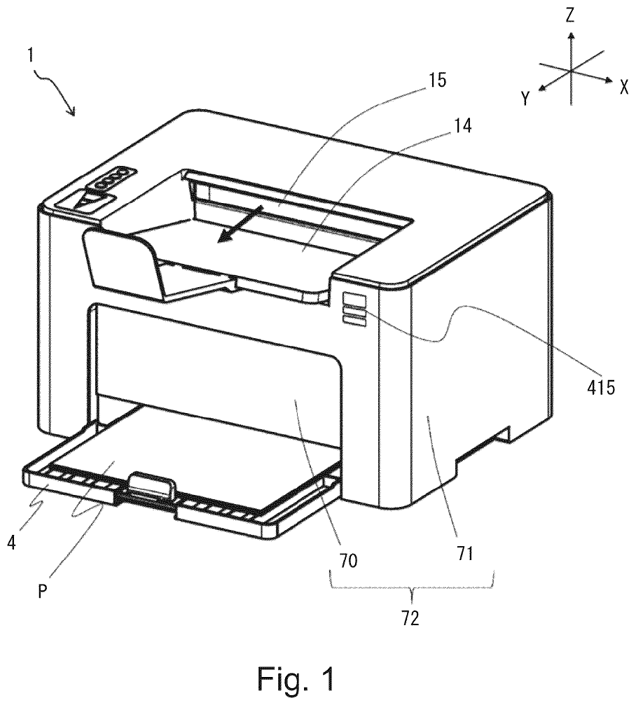

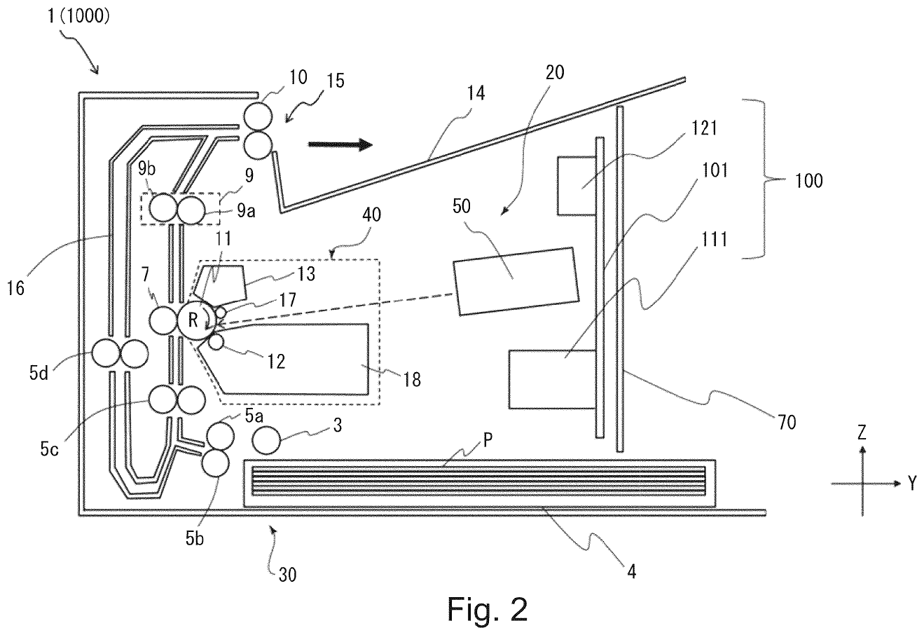

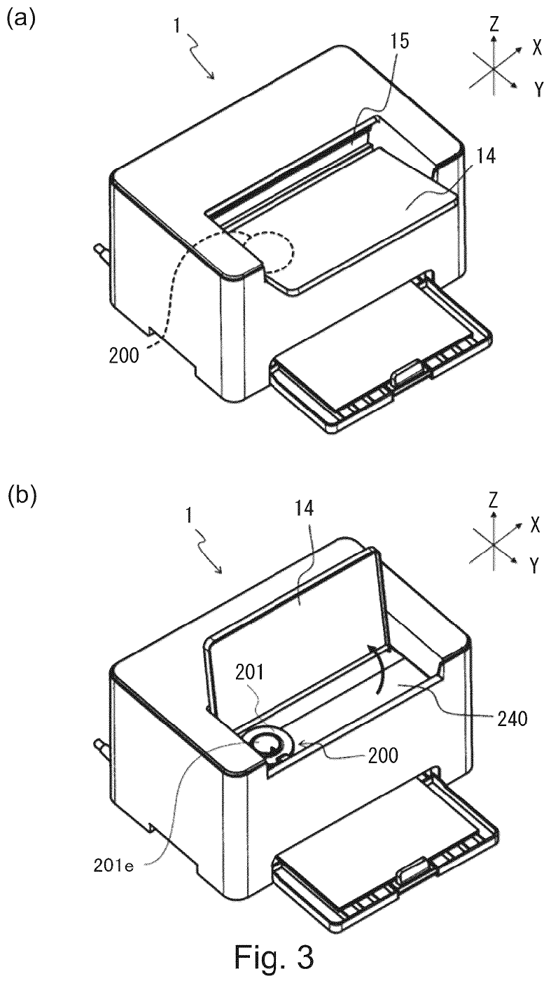

FIG. 1 is a perspective view of an image forming apparatus 1 according to an embodiment. FIG. 2 is a schematic sectional view of the image forming apparatus 1. The image forming apparatus 1 is a monochromatic printer for forming an image on a recording material on the basis of image information inputted from an external device. In the recording material, various sheet materials different in material including papers such as plain paper and thick paper, a plastic film such as a sheet for an overhead projector, special-shaped sheets such as an envelope and index paper, a cloth, and the like are included.

Further, in the following description, a height direction (opposite to a vertical direction) of the image forming apparatus 1 in the case where the image forming apparatus 1 is installed on a horizontal surface is referred to as a Z-direction. A direction which crosses the Z-direction and which is parallel to a rotational axis direction (main scan direction) of a photosensitive drum 11 described later is referred to as an X-direction. A direction crossing the X-direction and the Z-direction is referred to as a Y-direction. The X-direction, the Y-direction, and the Z-direction may preferably perpendicularly cross each other. Further, for convenience, in the X-direction, a positive (+) side is referred to as a right side, and the negative (−) side is referred to as a left side. In the Y-direction, the positive side is referred to as a front side or a front surface side, and the negative side is referred to as a rear side or a rear surface side. In the Z-direction, the positive side is referred to as an upper side, and the negative side is referred to as a lower side.

### [General Structure]

A general structure of the image forming apparatus 1 will be described using FIGS. 1 and 2. Incidentally, the image forming apparatus 1 and a supply pack 210 (see FIG. 10) described later constitutes an image forming system 1000. As shown in FIG. 2, the image forming apparatus 1 includes an image forming portion 20 for forming a toner image on the recording material, a feeding portion 30 for feeding a recording material P, a fixing portion 9 for fixing the toner image, formed by the image forming portion 20, on the recording material P, and a discharging roller pair 10.

The image forming portion 20 includes a scanner unit 50, a process unit 40 of an electrophotographic type, and a transfer roller 7 for transferring the toner image, formed on the photosensitive drum 11 of the process unit 40, onto the recording material P. The process unit 40 includes the photosensitive drum 11, and as members disposed at a periphery of the photosensitive drum 11, a cleaning unit 13, a charging roller 17, a developing roller 12, and an accommodating portion 18 for accommodating toner. Incidentally, the process unit 40 may be fastened to a casing 72 of the image forming apparatus 1 with screws, and includes a process unit demounted by a service person.

The photosensitive drum 11 as an image bearing member is a photosensitive member molded in a cylindrical shape. The photosensitive drum 11 in this embodiment includes, on a drum-shaped base material molded with aluminum, a photosensitive layer formed with a negatively chargeable organic photosensitive member. Further, the photosensitive drum 11 as the image bearing member is rotationally driven at a predetermined process speed in a predetermined direction (R direction in FIG. 2) by a motor.

The charging roller 17 contacts the photosensitive drum 11 at a predetermined press-contact force and forms a charging portion. Further, a desired charging voltage is applied to the charging roller 17 by a high-charging-voltage power source, so that the charging roller 17 electrically charges a surface of the photosensitive drum 11 uniformly to a predetermined potential. In this embodiment, the photosensitive drum 11 is charged to a negative polarity by the charging roller 17.

The scanner unit 50 irradiates the photosensitive drum 11, by using a rotating polygonal mirror, with laser light corresponding to image information inputted from the external device, so that the surface of the photosensitive drum 11 is subjected to scanning exposure. By this light exposure, an electrostatic latent image depending on the image information is formed on the surface of the photosensitive drum 11. Incidentally, the scanner unit 50 is not limited to a laser scanner device, but for example, an LED exposure device including an LED array in which a plurality of LEDs are arranged along a longitudinal direction of the photosensitive drum 11 may be employed.

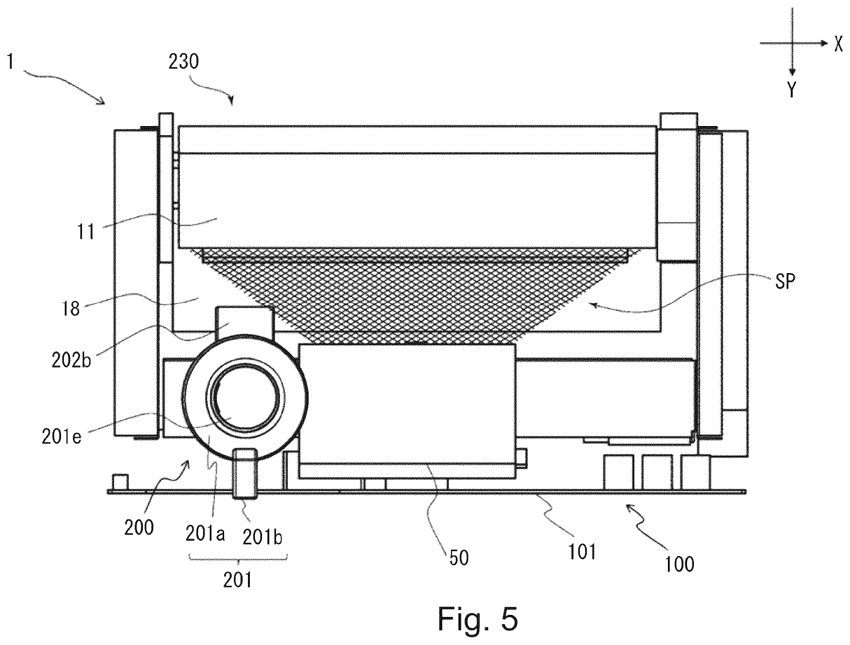

The developing roller 12 is rotatably supported by the accommodating portion 18. Further, the developing roller 12 is disposed at an opening of a developing container 230 (see FIG. 5) including the accommodating portion 18 so as to oppose the photosensitive drum 11. Incidentally, the accommodating portion 18 may be provided with a supplying roller for applying the toner as a developer, accommodated in the accommodating portion 18, onto the surface of the developing roller 12.

The process unit 40 in this embodiment uses a contact development type as a development type. That is, a toner layer carried on the developing roller 12 contacts the photosensitive drum 11 at a developing portion (developing region) where the photosensitive drum 11 and the developing roller 12 oppose each other. To the developing roller 12, a developing voltage is applied by a high-developing-voltage power source. Under application of the developing voltage, the toner carried on the developing roller 12 is transferred from the developing roller 12 onto the drum surface in accordance with a potential distribution of the surface of the photosensitive drum 11, so that the electrostatic latent image is developed into a toner image.

Further, the toner in this embodiment is a so-called non-magnetic one-component developer which does not contain a magnetic component and in which the toner is carried on the developing roller 12 principally by an intermolecular force or an electrostatic force (mirror force). However, a one-component developer containing a magnetic component may also be used. Further, in the one-component developer, an additive (for example, wax or silica fine particles) for adjusting flowability and charging performance of the toner is contained in addition to toner particles in some cases. Further, as the developer, a two-component developer constituted by non-magnetic toner and a magnetic carrier may also be used. In the case where the developer having a magnetic property is used, as the developer carrying member, for example, a cylindrical developing sleeve inside of which a magnet is disposed is used.

A fixing portion 9 is of a heat fixing type in which an image fixing process is performed by heating and melting the toner on the recording material. The fixing portion 9 includes a heating roller 9a incorporating therein a fixing heater, and a pressing roller 9b press-contacting the heating roller 9a.

The feeding portion 30 includes a cassette 4 on which recording materials P are stacked, and as a conveying portion, a picking-up roller 3, a feeding roller 5a, and a separation roller 5b. At a part of an end surface of the image forming apparatus on the front side, a front cover 70 is provided and covers a circuit board 100. The casing 72 includes the front cover 70, a discharge tray 14, and an outer casing cover 71 constituting an outer casing of the image forming apparatus 1 other than the front cover 70 and the discharge tray 14. The casing 72 is provided with a discharge opening 15 through which a sheet to be discharged to the discharge tray 14 passes.

As shown in FIG. 2, the image forming apparatus 1 includes the circuit board 100. The circuit board 100 is constituted by a wiring board 101 formed with an insulating member and electronic components 111 and 121 soldered to the wiring board 101. On or inside a board of the wiring board 101, wiring of an electroconductor is provided, and therefore, the electronic components 111 and 121 are electrically connected to each other. The circuit board 100 has functions such that an AC (alternating current) supplied from an outside of the image forming apparatus is converted into a DC (direct current) and such that an input voltage is converted for obtaining a predetermined voltage value necessary for an image forming process.

The circuit board 100 is disposed in a direction such that a surface of the wiring board 101 on which the electronic components 111 and 121 are mounted crosses a discharging direction. Further, the wiring board 101 is provided between the front cover 70 and the scanner unit 50 with respect to the discharging direction. The electronic components 111 and 121 are provided on the surface of the wiring board 101 on a side opposing the scanner unit 50.

### [Image Forming Mode]

An operation in an image forming mode of the image forming apparatus 1 will be described. The image forming mode in this embodiment is, as shown in FIG. 1 and part (a) of FIG. 3, a mode in which an image is formed on the recording material P in a state in which the discharge tray 14 is in a closed position. When an instruction of image formation is inputted to the image forming apparatus 1, on the basis of the image information inputted from an external computer connected to the image forming apparatus 1, an image forming process by the image forming portion 20 is started. The scanner unit 50 emits the laser light toward the photosensitive drum 11 on the basis of the inputted image information. At this time, the photosensitive drum 11 is charged in advance by the charging roller 17, and is irradiated with the laser light, so that the electrostatic latent image is formed on the photosensitive drum 11. Thereafter, this electrostatic latent image is developed by the developing roller 12, so that the toner image is formed on the photosensitive drum 11.

In parallel to the above-described image forming process, the pick-up roller 3 of the feeding portion 30 sends the recording material P supported by the cassette 4. The recording material P is separated one by one by the feeding roller 5a and the separation roller 5b, and is conveyed to a conveying roller pair 5. Then, by the conveying roller pair 5c, the recording material P is conveyed toward a transfer nip formed by a transfer roller 7 and the photosensitive drum 11.

To the transfer roller 7, a transfer voltage is applied from a high-transfer-voltage power source, so that the toner image carried on the photosensitive drum 11 is transferred onto the recording material P conveyed by the conveying roller pair 5c. The recording material P onto which the toner image is transferred is conveyed to the fixing portion 9, where the toner image is heated and pressed when the recording material P passes through a nip between the heating roller 9a and the pressing roller 9b of the fixing portion 9. By this, toner particles are melted and are thereafter stuck, so that the toner image is fixed on the recording material P. The recording material P passed through the fixing portion 9 is discharged through the discharge opening 15 to an outside of the image forming apparatus 1 (outside of the printer) by a discharging roller pair 10, so that the discharged recording materials P are stacked on the discharge tray 14.

In the case where images are formed on double (both) sides of the recording material P, the discharging roller pair 10 subjects the recording material P, on which first surface (side) the image is formed, to switch-back, and guides the recording material P to a double-side conveying passage 16.

The recording material P guided to the double-side conveying passage 16 is conveyed toward the transfer roller 7 again by a double-side conveying roller pair 5d. The recording material P is discharged to the outside of the image forming apparatus 1 by the discharging roller pair 10 after the image is formed on a second surface (side) by the transfer roller 7. Further, the toner remaining on the photosensitive drum 11 after the toner images are transferred on the recording material P is removed by a cleaning unit 13.

### [Supplying Portion]

Next, a supplying portion (mounting portion) 200 will be described using part (a) of FIG. 3 to part (c) of FIG. 7. The discharge tray 14 is supported so as to be openable and closable between a closed position where the recording material P is capable of being stacked and the operation in the image forming mode is capable of being executed as shown in part (a) of FIG. 3 and an open position where the discharge tray 14 is opened as shown in part (b) of FIG. 3. An unshown open/close detecting portion can detect that the discharge tray 14 is positioned in which one of the open position and the closed position. The discharge tray 14 covers the supplying portion 200 in the closed position. When the discharge tray 14 is moved to the open position, a top surface portion 240 and the supplying portion 200 disposed adjacent to the top surface portion 240 are exposed. The supplying portion 200 is constituted so that a supply pack 210 as a toner container described later are detachably mountable (mountable) to the supplying portion 200. The image forming apparatus 1 is constituted so that a user or the service person is capable of supplying the toner from the outside into the image forming apparatus 1 without dismounting the developing container 230 from the casing 72 (see FIG. 1).

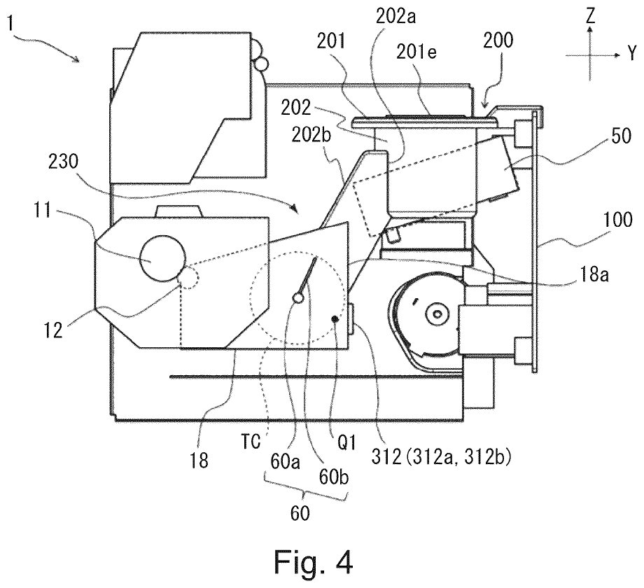

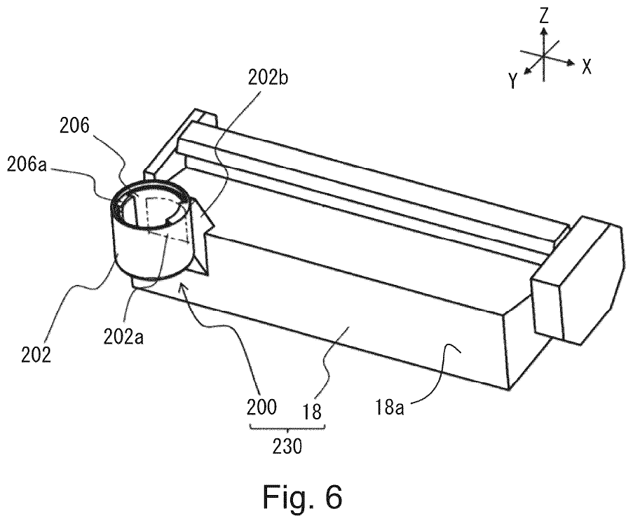

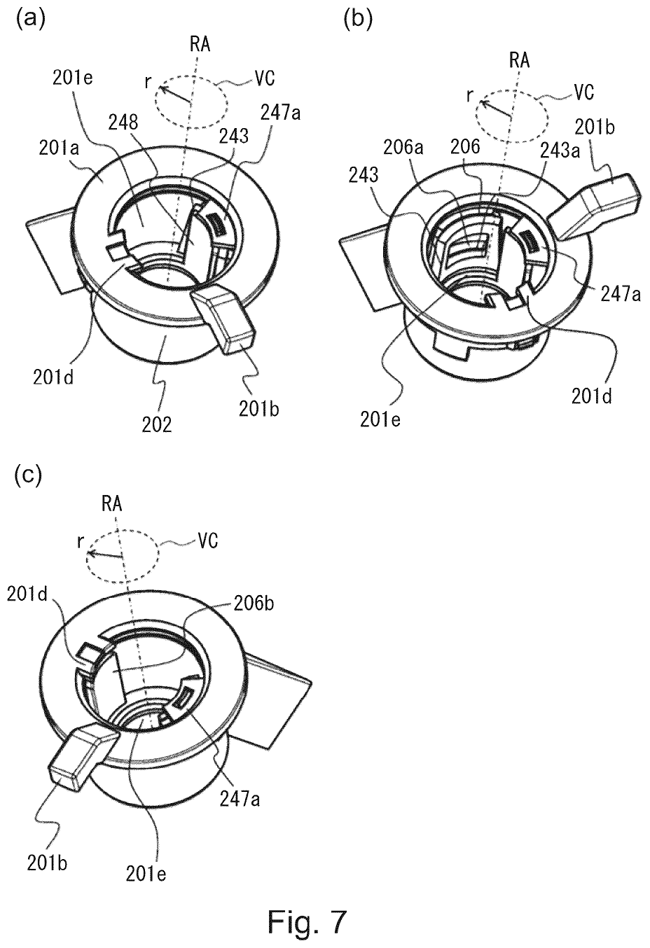

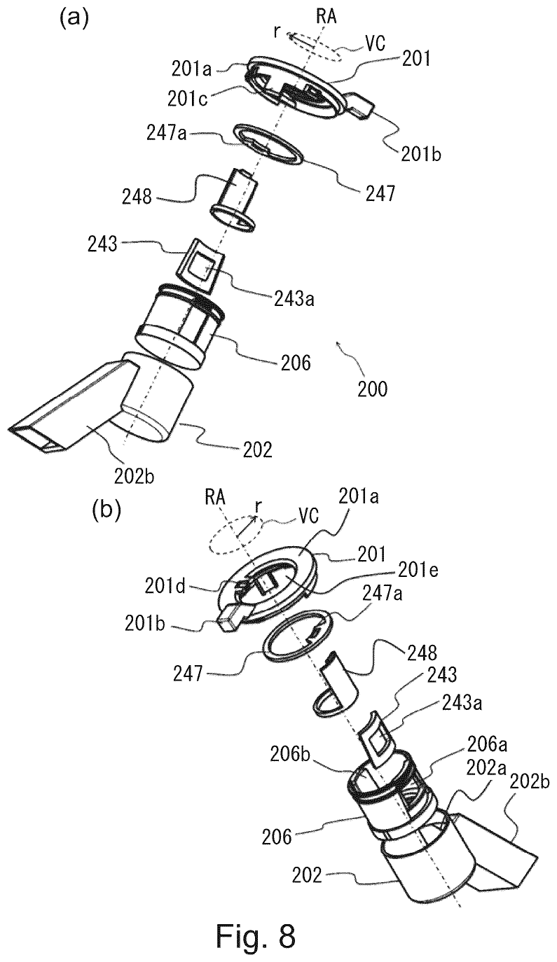

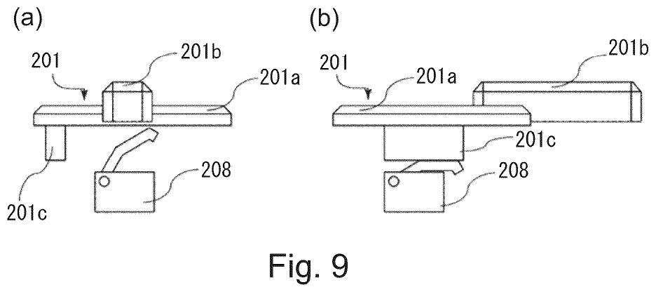

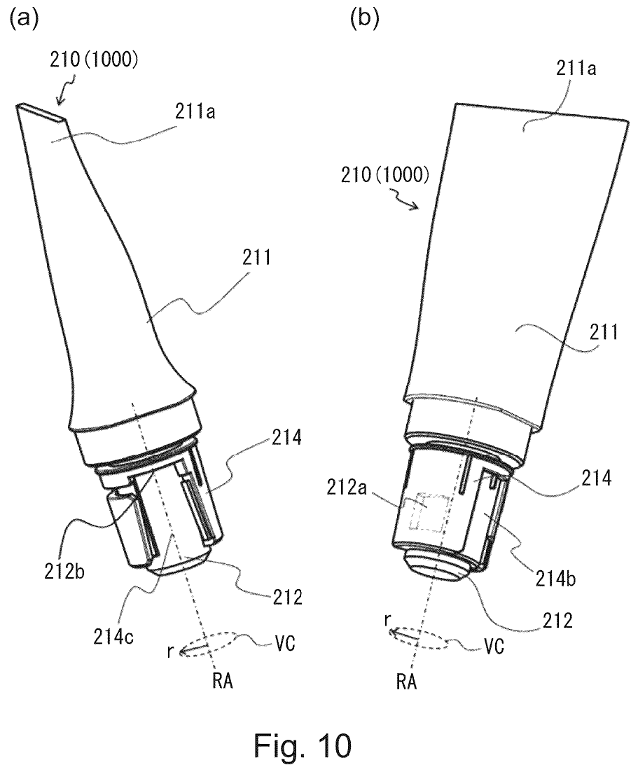

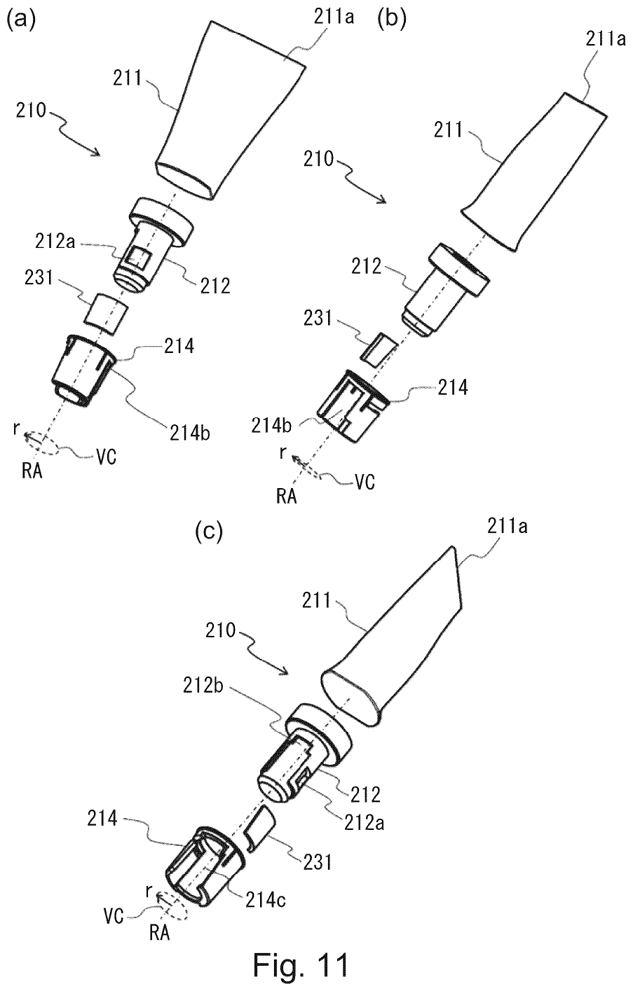

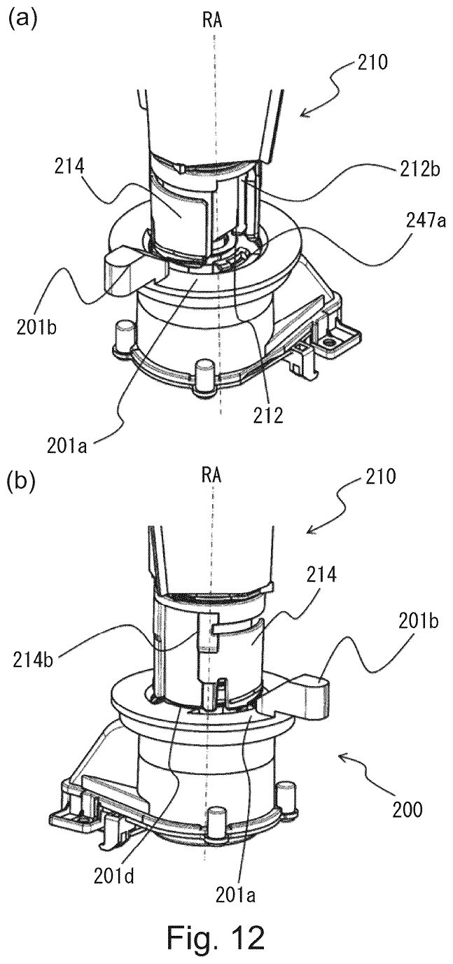

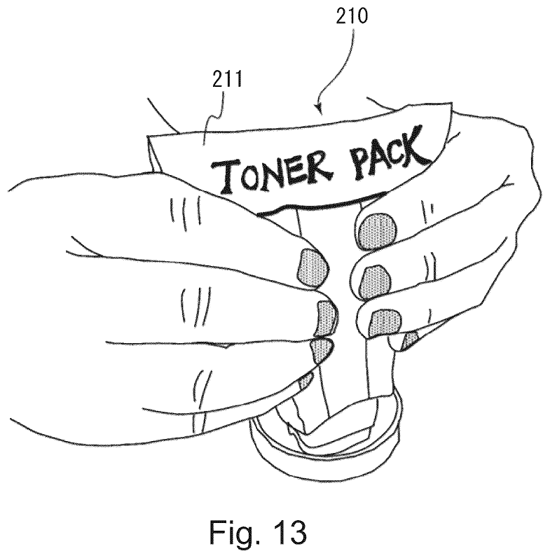

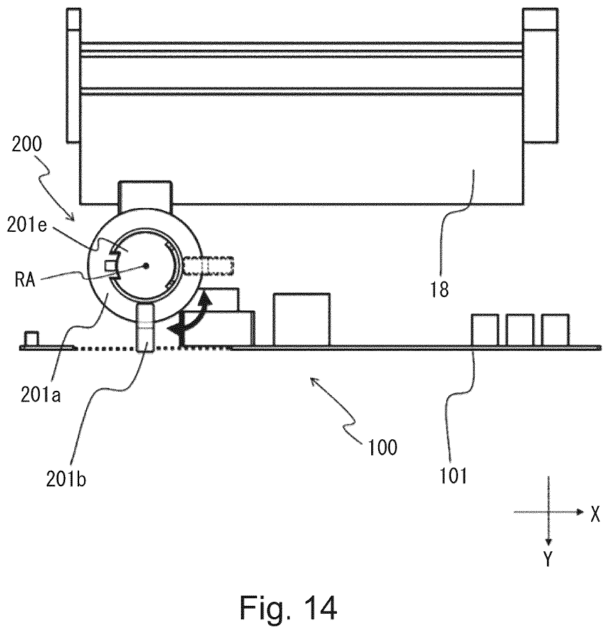

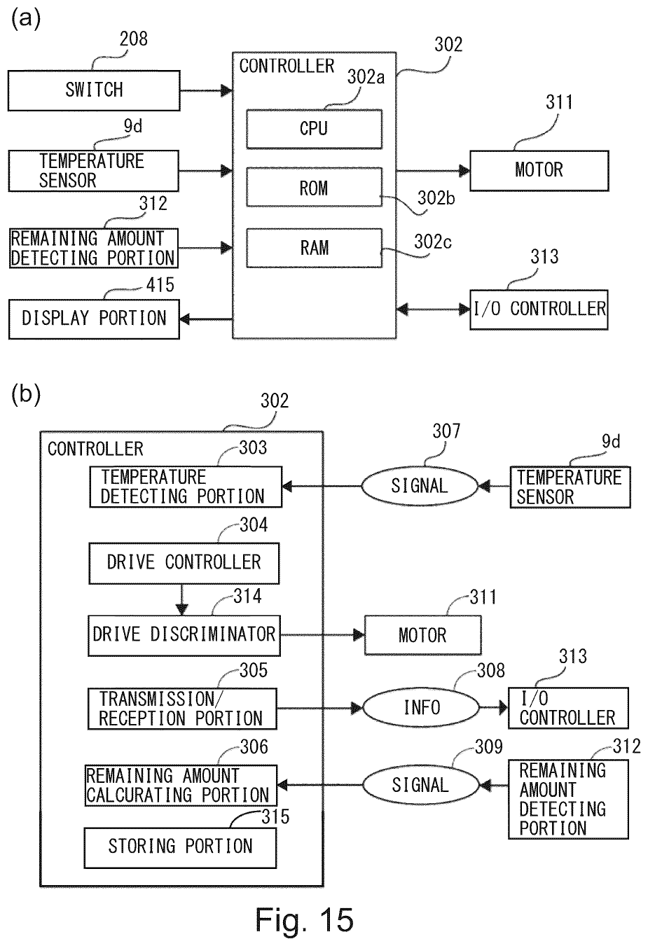

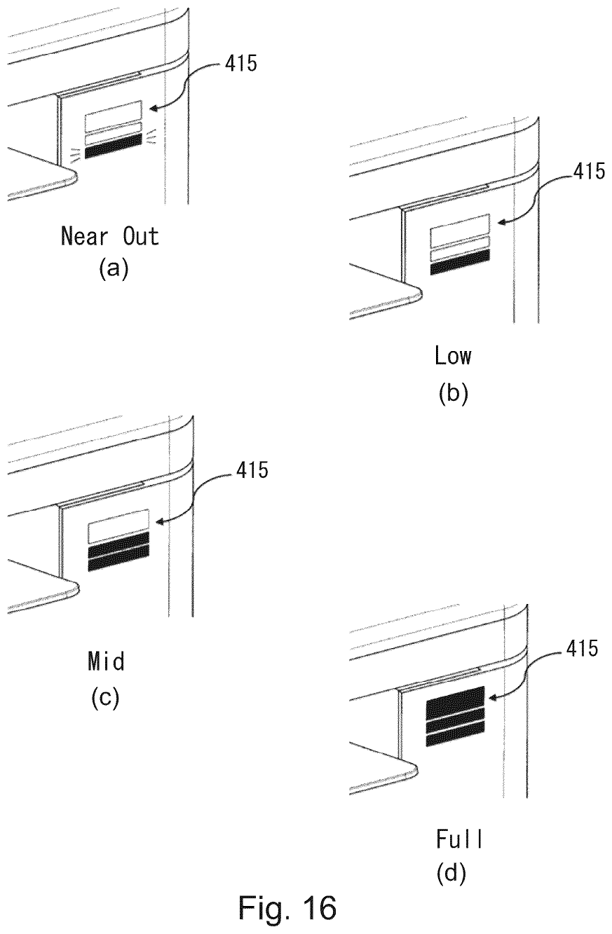

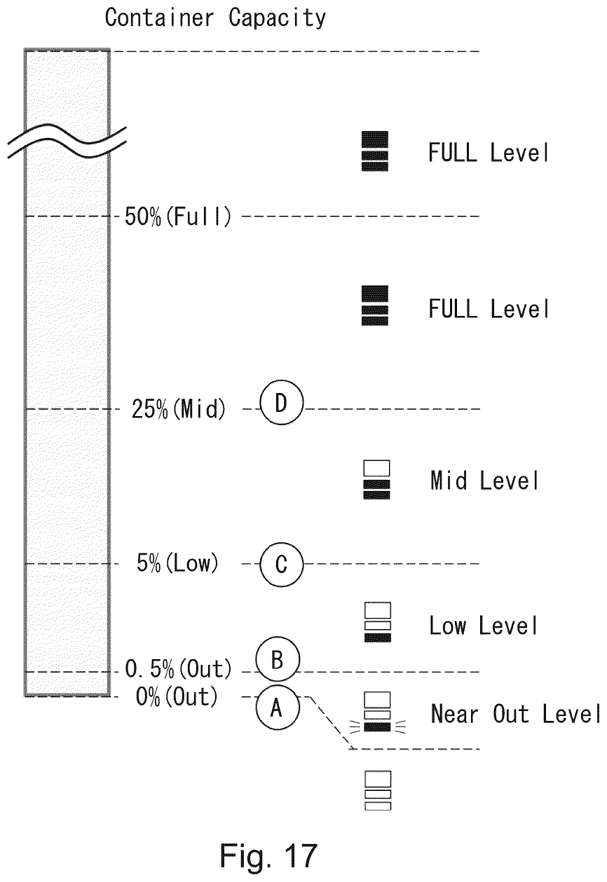

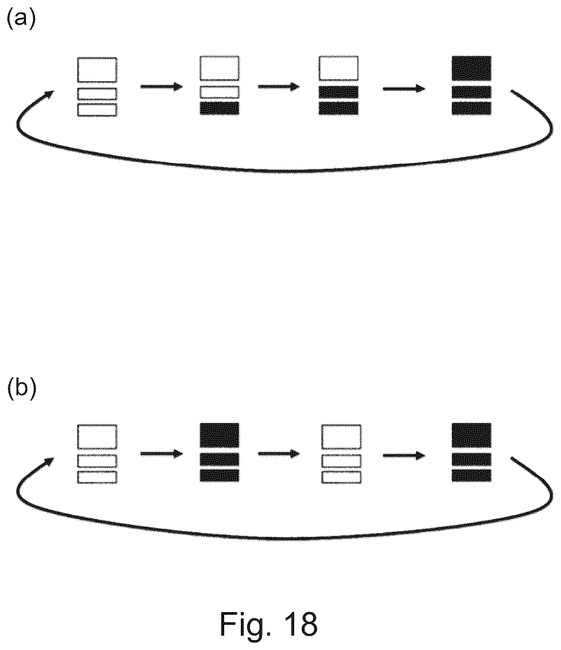

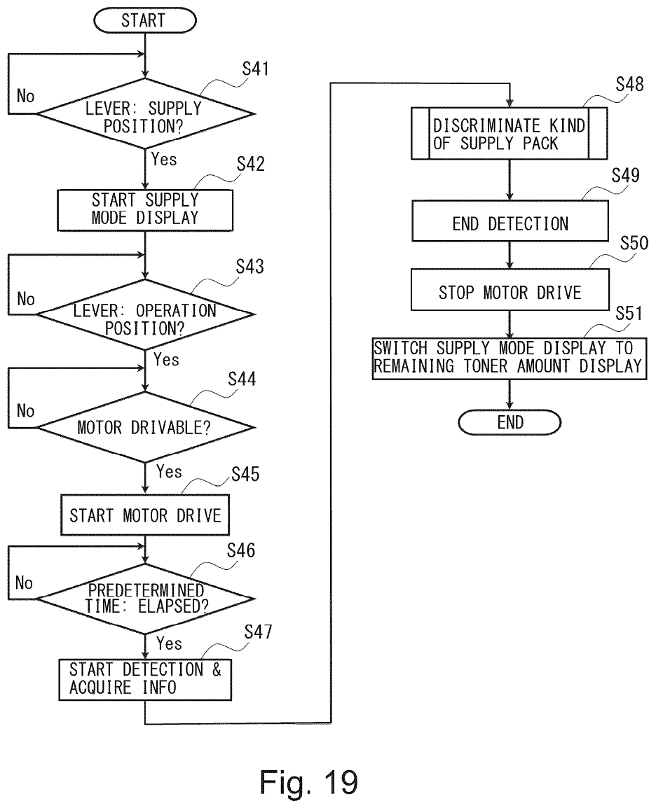

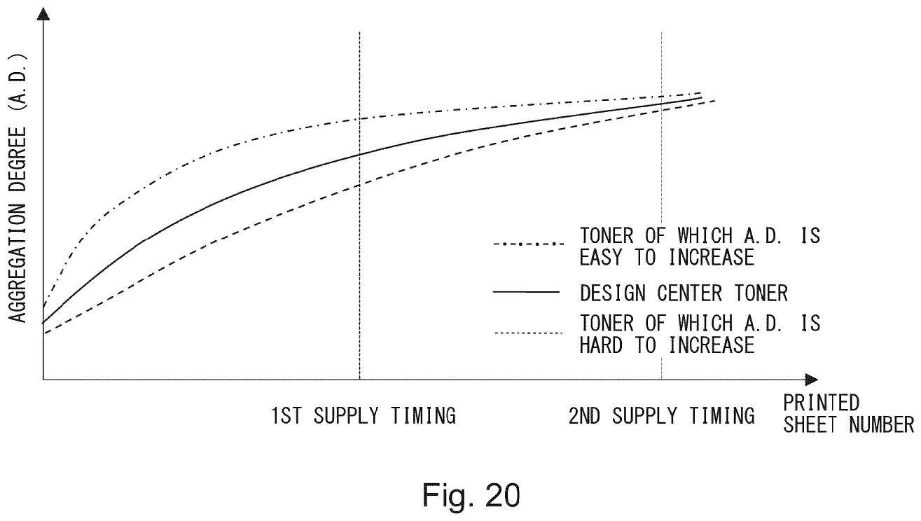

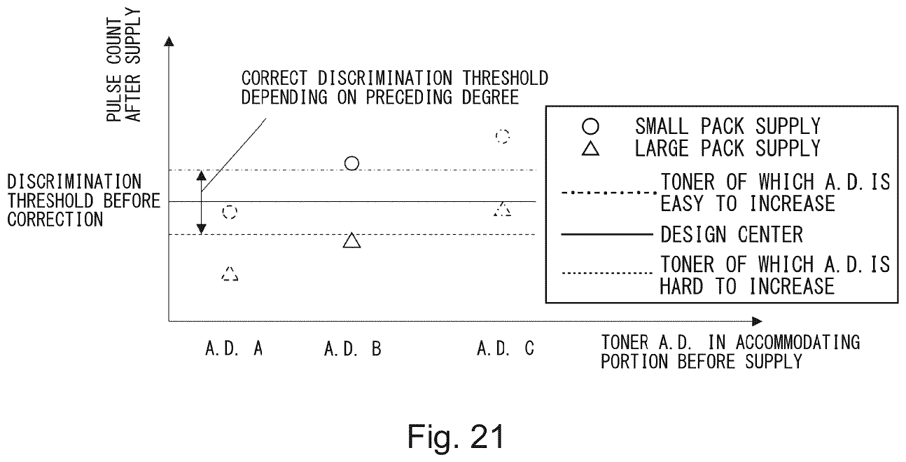

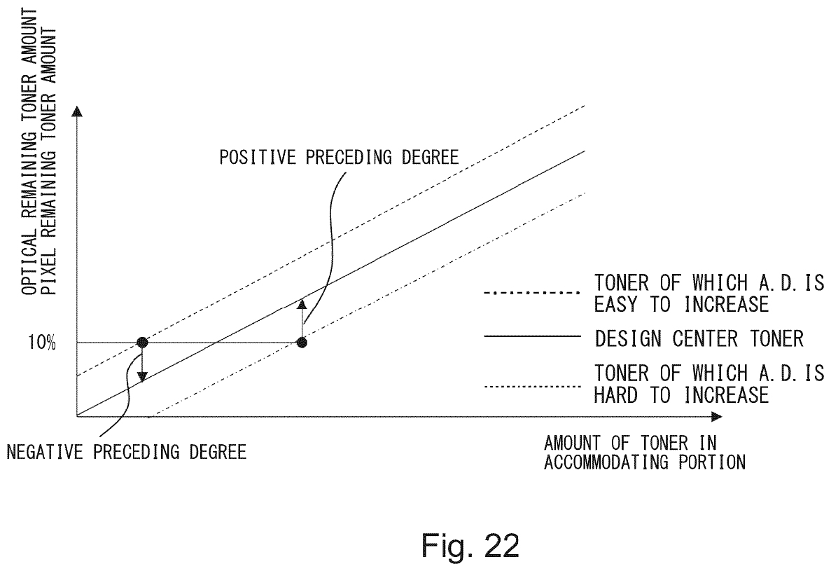

FIG. 4 is a sectional view of the developing container 230 of the image forming apparatus 1. FIG. 5 is a schematic view of the image forming apparatus 1, as viewed from above, in a state in which the outer casing cover 71 is discharged. FIG. 6 is a perspective view of the developing container 230. Incidentally, in FIG. 6, a lever 201 of the supplying portion 200 and a part of a member attached thereto are omitted.

As shown in FIGS. 4 to 6, the developing container 230 includes the accommodating portion 18 and the supplying portion 200.

The supplying portion 200 includes a cylindrical passage member 202 and a main assembly shutter 206 (see part (b) of FIG. 7). The passage member 202 includes an extended portion 202b extended to the accommodating portion 18 and a side surface opening 202a connected to the extended portion 202b. The toner discharged from the supply pack 210 mounted on the supplying portion 200 passes through a main assembly shutter opening 206a of the main assembly shutter 206, and side surface opening 202a and the extended portion 202b of the passage member 202, and is supplied to the accommodating portion 18.

The extended portion 202b is connected to the accommodating portion 18 on one end side with respect to the longitudinal direction of the developing container 230, i.e., the X-direction. Inside the accommodating portion 18, as shown in FIG. 4, a stirring member 60 rotatable about a rotation shaft 60a extending in the X-direction is provided. The stirring member 60 includes a blade portion 60b fixed to the rotation shaft 60a, and is driven and rotated by a motor 311 (see FIG. 15), so that the stirring member 60 not only smoothens the toner in the accommodating portion 18 supplied from the supply pack 210 by stirring the toner but also conveys the toner toward the developing roller 12. Incidentally, in this embodiment, the stirring member 60 is constituted by the rotation shaft 60a and the blade portion 60b, but as a constitution in which the toner is supplied and extended over a full length of the accommodating portion 18, a helical-shaped stirring member may also be used.

The stirring member 60 has a function of circulating, in the accommodating portion 18, the toner which is not used for development and which is scraped off from the developing roller 12 and of uniformizing the toner in the accommodating portion 18. Incidentally, the form of the stirring member 60 is not limited to a rotation form. For example, a stirring member of a swing form may be employed.

Further, in addition to the stirring member 60, another stirring member may be provided inside the accommodating portion 18.

Further, on a side surface 18a of the accommodating portion 18 positioned on a side opposite from the developing roller 12, a remaining amount detecting portion (remaining toner amount detecting portion) 312 for detecting a toner amount of the toner in the accommodating portion 18 is provided, and the remaining amount detecting portion 312 includes a light emitting portion 312a and a light receiving portion 312b. The light emitting portion 312a and the light receiving portion 312b are arranged and disposed in the X-direction. The light emitted from the light emitting portion 312a pass through an inside of the accommodating portion 18 and is received by the light receiving portion 312b. That is, the light emitting portion 312a and the light receiving portion 312b form an optical path Q1 inside the accommodating portion 18. The optical path Q1 extends in the X-direction. Incidentally, the light emitting portion 312a and the light receiving portion 312b may be prepared by disposing a light emitting element and a light receiving element inside the accommodating portion 18, or by disposing these elements outside the accommodating portion 18, so that the light may be guided to an inside and an outside of the accommodating portion 18 by a guiding portion.

Further, the light emitting portion 312a and the light receiving portion 312b are provided at a central portion of the accommodating portion 18 with respect to the X-direction. Specifically, the light emitting portion 312a and the light receiving portion 312b are disposed in a region corresponding to a laser passing space SP (see FIG. 5) with respect to the X-direction. The laser passing space SP is a space through which the laser light emitted from the scanner unit 50 toward the photosensitive drum 11 passes. Thus, by providing the light emitting portion 312a and the light receiving portion 312b at the central portion of the accommodating portion 18, the remaining toner amount of the toner in the accommodating portion 18 can be satisfactorily detected. That is, at an end portion of the accommodating portion 18 with respect to the X-direction, the developer (toner) is localized in some instances, but a degree of localization of the developer at the central portion of the accommodating portion 18 is small, so that a practical remaining toner amount can be detected.

Incidentally, in this embodiment, an LED is used as the light emitting portion 312a, and a phototransistor put in an ON state by the light from the LED is used as the light receiving portion 312b, but the present invention is not limited thereto. For example, a halogen lamp or a fluorescent lamp may be applied to the light emitting portion 312a, and a photodiode or an avalanche photodiode may be applied to the light receiving portion 312b.

The light receiving portion 312b which is the phototransistor receives the light emitted from the light emitting portion 312a and outputs a signal (current) depending on a received light quantity. This signal is converted into a voltage, and is inputted to a controller 302 (see FIG. 15). That is, the light receiving portion 312b changes an output value on the basis of an amount of the toner (developer) accommodated in the accommodating portion 18.

The controller 302 discriminates whether or not the light receiving portion 312b receives the light from the light emitting portion 312a, on the basis of an inputted voltage level. The controller 302 calculates a toner amount (developer amount) in the accommodating portion 18 by measuring a length of a time in which the light receiving portion 312b receives the light when the toner in the accommodating portion 18 is stirred for a certain time by the stirring member 60. Specifically, the controller 302 discriminates whether or not the light receiving portion 312b receives the light from the light emitting portion 312a with a predetermined sampling interval (for example, an interval of 5 msec) during one rotation of the stirring member 60, and employs the number of times of reception of the light as a pulse count. The controller 302 resets the pulse count every (one) rotation of the stirring member 60, and calculates the pulse count. The controller 302 calculates the remaining toner amount by using the pulse count. Further, a ROM 302b of the controller 302 in part (a) of FIG. 15 preliminarily stores a threshold table at the time of consumption in which the pulse count and the remaining toner amount are correlated with each other, and a remaining amount calculating portion 306 discriminates the remaining toner amount on the basis of the pulse count and the threshold table at the time of consumption. A discrimination result is stored in a RAM 302c.

Specifically, as shown in FIG. 4, the optical path Q1 of the remaining amount detecting portion 312 is set so as to overlap with a rotation locus TC of the stirring member 60 as viewed in an axial direction of a rotation shaft 60a of the stirring member 60. In other words, the light emitted from the light emitting portion 312a of the remaining amount detecting portion 312 passes through the inside of the accommodating portion 18 in the rotation locus TC of the stirring member 60 as viewed in the axial direction of the stirring member 60. Then, a time in which the optical path Q1 is blocked by the toner conveyed by the stirring member 60 when the stirring member 60 is rotated by one turn, i.e., a time in which the light receiving portion 312b does not receive the light from the light emitting portion 312a changes depending on the remaining toner amount.

That is, when the remaining toner amount is large, the optical path Q1 is liable to be blocked by the toner, and therefore, a light receiving time of the light receiving portion 312b becomes short. On the other hand, when the remaining toner amount is small, the light receiving time of the light receiving portion 312b becomes long. Accordingly, the controller 302 is capable of discriminating a remaining toner amount level of the toner in the accommodating portion 18 on the basis of the light receiving time of the light receiving portion 312b as described above.

Incidentally, a detecting and estimating method of the remaining toner amount is not limited to the above-described method (type), but it is possible to employ remaining toner amount detecting and detecting methods of various well-known types. For example, two or more metal plates or electroconductive resin sheets which extend in a longitudinal direction of the developing roller 12 are disposed on an inner wall of the accommodating portion 18, and electrostatic capacity between the two metal plates or the two electroconductive resin sheets is measured, so that the remaining toner amount may be detected and estimated. Further, a load cell is provided in the form of supporting the developing container 230 from below, and on the basis of a weight measured by the load cell, the remaining toner amount may be calculated.

A detailed constitution of the supplying portion 200 to which the supply pack 210 is mounted will be described. Parts (a) and (b) of FIG. 7 are perspective views of the supplying portion 200 as viewed in the same direction. Part (c) of FIG. 7 is a perspective view of the supplying portion 200 as viewed from an angle different from an angle in part (a) of FIG. 7. Parts (a) and (b) of FIG. 8 are exploded perspective views of the supplying portion 200.

The supplying portion 200 includes, as shown in parts (a) and (b) of FIG. 8, the lever (operating portion) 201, a rotation restricting member 247, a cover 248, a sealing member 243, the main assembly shutter 206, and the passage member 202. The main assembly shutter 206 is constituted so as to be rotatable (movable) about a rotational axis RA relative to the passage member 202. The main assembly shutter 206 is disposed inside the cylindrical passage member 202 and is provided with the main assembly shutter opening 206a. Further, the main assembly shutter 206 is provided with a main assembly shutter engaging portion 206b engageable with a container shutter portion-to-be-engaged 214b of a container shutter 214 described later. When a virtual circle about the rotational axis RA is a virtual circle VC, the main assembly shutter engaging portion 206b is a projected portion projected inward a radial direction r of the virtual circle VC.

In the case where the main assembly shutter 206 is positioned in a closed position (second closed position) shown in part (a) of FIG. 7, the main assembly shutter opening 206a and the side surface opening 202a (see part (b) of FIG. 8) of the passage member 202 do not overlap with each other. That is, the main assembly shutter opening 206a and the side surface opening 202a of the passage member 202 do not communicate with each other. For this reason, the side surface opening 202a is shielded by the main assembly shutter 206, so that the toner is not discharged to the extended portion 202b of the passage member 202. When the main assembly shutter 206 is positioned in an open position (second open position) shown in part (b) of FIG. 7, the main assembly shutter opening 206a and the side surface opening 202a of the passage member 202 overlap with each other. That is, the main assembly shutter opening 206a and the side surface opening 202a of the passage member 202 communicate with each other. For this reason, the toner supplied from the supply pack 210 mounted to the supplying portion 200 passes through the main assembly shutter opening 206a and the side surface opening 202a and becomes dischargeable to the extended portion 202b of the passage member 202.

Although described specifically later, the main assembly shutter 206 is moved (rotated) between the closed position and the open position by rotating the lever 201 in a state in which the supply pack 210 is mounted to the supplying portion 200. That is, the main assembly shutter 206 is moved from the closed position shown in part (a) of FIG. 7 to the open position shown in part (b) of FIG. 7 by rotating the lever 201 counterclockwise 90 degrees by the user.

At a periphery of the main assembly shutter opening 206a on an inner peripheral surface side of the main assembly shutter 206, the sealing member 243 is applied onto the main assembly shutter 206. The sealing member 243 is provided with a seal opening 243a. The sealing member 243 is applied onto the main assembly shutter 206 so that the seal opening 243a overlaps with the main assembly shutter opening 206a. When the main assembly shutter 206 is in the open position, the sealing member 243 seals a gap between the main assembly shutter 206 and a periphery of an inserting portion opening 212a of an inserting portion 212 of the supply pack 210 described later.

The rotation restricting member 247 is fixed to the passage member 202 and is provided inside the main assembly shutter 206. The rotation restricting member 247 includes a rotation restricting portion 247a for restricting rotation of the inserting portion 212 about the rotational axis RA in engagement with a rotation-restricted portion 212b of the inserting portion 212 of the supply pack 210 described later.

The lever 201 includes a ring portion 201a provided with an inserting opening 201e through which the inserting portion 212 of the supply pack 210 is inserted, and includes a gripping portion 201b provided integrally with the ring portion 201a. The lever 201 includes a lever engaging portion 201d projected inward the radial direction r of the virtual circle VC from the inner peripheral surface forming the inserting opening 201e. As shown in part (c) of FIG. 7, the lever engaging portion 201d as an engaging portion is in the same phase as the main assembly shutter engaging portion 206b with respect to a circumferential direction of the virtual circle VC when the main assembly shutter 206 is in the closed position. In other words, the lever engaging portion 201d overlaps with the main assembly shutter engaging portion 206b as viewed in the rotational axis direction RA when the main assembly shutter 206 is in the closed position. The cover 248 is fixed to the passage member 202 via the main assembly shutter 206, and as shown in part (a) of FIG. 7, the cover 248 is a member for covering the main assembly shutter opening 206a when the main assembly shutter 206 is in the closed position.

When the image is formed on the recording material P, the toner in the accommodating portion 18 is stirred by the stirring member 60 (see FIG. 4), and the side surface opening 202a is shielded by the main assembly shutter 206 so that the toner does not leak out through the side surface opening 202a of the passage member 202. Accordingly, during the image formation, the lever 201 is positioned in an operation position (first position) shown in part (a) of FIG. 7 so that the main assembly shutter 206 is positioned in the closed position. On the other hand, when the toner is supplied from the supply pack 210 described later to the accommodating portion 18, there is a need to open the side surface opening 202a. Accordingly, during the toner supply, the lever 201 is positioned in a supplying position (second position) shown in part (b) of FIG. 7 so that the main assembly shutter 206 is positioned in the open position.

### (Detection of Operation Position and Supply Position of Lever)

Parts (a) and (b) of FIG. 9 are side views each showing the lever 201 and a switch 208 (detecting portion). The lever 201 includes, as shown in part (a) of FIG. 8 and part (a) of FIG. 9, a rib-to-be-detected 201c formed integrally with the ring portion 201a. Below the ring portion 201a, the switch 208 as a sensor is disposed. When the lever 201 is positioned in the operation position, the switch 208 is in an OFF state without contacting the rib-to-be-detected 201c. When the lever 201 is positioned in the supply position, the switch 208 contacts the rib-to-be-detected 201c and is in an ON state.

Thus, the switch 208 is turned off (OFF state) or on (ON state), so that it is possible to detect that the lever 201 is positioned in the operation position or the supply position. Further, the switch 208 is switched from the OFF state to the ON state, so that it is possible to detect that the lever 201 was moved from the operation position to the supply position. Further, the switch 208 is switched from the ON state to the OFF state, so that it is possible to detect that the lever 201 was moved from the supply position to the operation position.

### [Supply Pack]

A constitution of the supply pack 210 will be described using part (a) of FIG. 10 and part (c) of FIG. 11. Parts (a) and (b) of FIG. 10 are perspective views of the supply pack 210 as viewed from angles different from each other. Parts (a), (b), and (c) of FIG. 11 are exploded perspective views of the supply pack 210 as viewed from angles different from each other. Incidentally, in part (a) of FIG. 10, the inserting portion opening 212a as an opening is covered with the container shutter 214 and is not actually seen, and therefore is shown by a broken line.

As shown in part (a) of FIG. 10 to part (c) of FIG. 11, the supply pack 210 includes a pouch 211, the inserting portion 212 (end portion member), the container shutter 214, and a container shutter seal 231. The rotational axis RA is a rotational axis when the container shutter 214 is rotated relative to the inserting portion 212.

The pouch 211 is a container formed in a bag shape by subjecting a polypropylene sheet to pouch processing, and accommodates the toner inside thereof. The pouch 211 has a flat shape toward a side opposite from the inserting portion 212, and includes, at an end thereof, a pouch end portion 211a extending in a direction perpendicular to the rotational axis RA. Incidentally, in this embodiment, although the pouch is used as a toner accommodating portion of the supply pack 210, a bottle made of resin or a container made of paper, vinyl, or the like may be used.

The inserting portion 212 is a cylindrical member capable of being inserted into the inserting opening 201e of the lever 201, and is provided with the inserting portion opening 212a on a side surface extending in the direction of the rotational axis RA. The inserting portion 212 is provided at an end portion of the pouch 211 with respect to the direction of the rotational axis RA, and is a member for discharging the toner in the pouch 211 to an outside of the supply pack 210 through the inserting portion opening 212a. The inserting portion 212 further includes the rotation-restricted portion 212b. The rotation-restricted portion 212b is engaged with the rotation restricting portion 247a of the rotation restricting member 247 of the supplying portion 200, so that rotation of the inserting portion 212 about the rotational axis RA is restricted.

The container shutter 214 is a cylindrical member constituted so as to be concentrically with the inserting portion 212. The container shutter 214 is provided rotatably about the rotational axis RA relative to the inserting portion 212 on an outside of the inserting portion 212 with respect to the radial direction r of the virtual circle VC. Further, the container shutter 214 is constituted so as to be moved (rotated) between a closed position (first closed position) where the container shutter 214 closes the inserting portion opening 212a and an open position (second open position) where the container shutter 214 opens the inserting portion opening 212a.

The container shutter 214 is provided with a container shutter opening 214c (opening). When the container shutter 214 is in the open position, the container shutter opening 214c and the inserting portion opening 212a overlap and communicate with each other. At this time, the toner becomes dischargeable from the inside of the supply pack 210 to the outside of the supply pack 210 through the container shutter opening 214c and the inserting portion opening 212a. When the container shutter 214 is in the closed position, the inserting portion opening 212a is closed by the container shutter 214. At this time, the toner is not discharged from the inside of the supply pack 210 to the outside of the supply pack 210. When the supply pack 210 is not mounted to the image forming apparatus 1, the container shutter 214 is in the closed position. Further, when the container shutter 214 is in the closed position, the rotation-restricted portion 212b of the inserting portion 212 is exposed from the container shutter opening 214c. This will be described later.

On an outer peripheral surface of the container shutter 214, a container shutter portion-to-be-engaged 214b engageable with the lever engaging portion 201d of the lever 201 and the main assembly shutter engaging portion 206b of the main assembly shutter 206 when the supply pack 210 is mounted to the supplying portion 200 is provided. The container shutter portion-to-be-engaged 214b as a portion-to-be-engaged is a recessed portion recessed from the outer peripheral surface of the container shutter 214 toward the inside of the container shutter 214 in the radial direction r of the virtual circle VC and extends to an end of the container shutter 214 on a side remote from the pouch 211 with respect to the direction of the rotational axis RA. The container shutter portion-to-be-engaged 214b receives a force from the lever engaging portion 201d of the lever 201 in a rotational direction about the rotational axis RA, so that the container shutter 214 is rotated relative to the inserting portion 212. Incidentally, the container shutter portion-to-be-engaged 214b is not required to be the recessed portion when a constitution in which the container shutter 214 is rotated by rotation of the lever 201 in engagement with the lever 201 is employed.

The container shutter seal 231 is applied onto the inner peripheral surface of the container shutter 214. The container shutter seal 231 seals between a periphery of the inserting portion opening 212a of the inserting portion 212 and the container shutter 214 when the container shutter 214 is in the closed position.

### [Mounting of Supply Pack and Toner Supply]

Next, a mounting method of the supply pack 210 to the supplying portion 200 and a toner supplying method using the supply pack 210 will be described using part (a) of FIG. 12 to FIG. 13. Parts (a) and (b) of FIG. 12 are perspective views of the supplying portion 200 of the image forming apparatus 1 and the supply pack 210 immediately before being mounted to the supplying portion 200 as viewed in different directions from each other. FIG. 13 is a perspective view showing a state in which the user grips the pouch 211 with user's hands.

As shown in parts (a) and (b) of FIG. 12, when the supply pack 210 is mounted to the supplying portion 200 of the image forming apparatus 1, there is a need that the supply pack 210 is aligned with the supplying portion 200 in two positions. This alignment is alignment with respect to the rotational direction about the rotational axis RA, and becomes possible in a state in which the container shutter 214 is in the closed position. In one position, as shown in part (a) of FIG. 12, the rotation-restricted portion 212b of the inserting portion 212 exposed from the container shutter opening 214c of the container shutter 214 and the rotation restricting portion 247a of the rotation restricting member 247 are aligned with each other. In the other position, as shown in part (b) of FIG. 13, the container shutter portion-to-be-engaged 214b and the lever engaging portion 201d are aligned with each other. When the alignment in the other position can be made, the alignment between the container shutter portion-to-be-engaged 214b and the main assembly shutter engaging portion 206b can also be made. This is because the lever engaging portion 201d and the main assembly shutter engaging portion 206b overlap with each other as viewed in the direction of the rotational axis RA.

In a state in which the mounting of the supply pack 210 to the supplying portion 200 is completed, the container shutter portion-to-be-engaged 214b not only engages with the lever engaging portion 201d but also engages with the main assembly shutter engaging portion 206b of the main assembly shutter 206. Further, the rotation-restricted portion 212b of the inserting portion 212 engages with the rotation restricting portion 247a. In this state, as shown in FIG. 14, the user grips the gripping portion 201b and rotates the lever 201 clockwise 90 degrees, so that the lever 201 is rotated from the first position to the second position relative to the inserting portion 212.

At this time, the container shutter portion-to-be-engaged 214b is pressed by the lever engaging portion 201d, and the container shutter 214 is rotated together with the lever 201 from the closed position and the open position. The main assembly shutter engaging portion 206b is pressed by the container shutter portion-to-be-engaged 214b, and the main assembly shutter 206 is rotated together with the lever 201 and the container shutter 214 from the closed position to the open position. Thus, the main assembly shutter 206 is constituted so as to be rotated by the lever 201 through the container shutter 214, so that the lever 201 is not rotated even when the lever 201 is rotated from the first position to the second operation in a state in which the supply pack 210 is not mounted to the supplying portion 200. Therefore, even when the lever 201 is operated by the user in the state in which the supply pack 210 is not mounted to the supplying portion 200, the main assembly shutter 206 does not open.

When the lever 201 is in the second position in the state in which the supply pack 210 is mounted to the supplying portion 200, both the container shutter 214 and the main assembly shutter 206 are in the open position, so that the container shutter opening 214c and the main assembly shutter opening 206a communicate with each other. In this state, as shown in FIG. 13, the user loosens (deforms) the pouch 211 with user's hands, so that the toner in the pouch 211 is moved together with the air toward the inserting portion 212. Then, the toner moved into the inserting portion 212 passes through the inserting portion opening 212a, the container shutter opening 214c, and the main assembly shutter opening 206a, and is supplied to the accommodating portion 18 of the developing container 230.

In the case where the toner supply is completed and the supply pack 210 is dismounted from the supplying portion 200, as shown in FIG. 14, the user grips the gripping portion 201b and rotates the lever 201 counterclockwise 90 degrees. By this operation, the lever 201 is rotated relative to the inserting portion 212 from the second position to the first position. At this time, the container shutter portion-to-be-engaged 214b is pressed by the lever engaging portion 201d, so that the container shutter 214 is rotated together with the lever 201 from the open position to the closed position. The main assembly shutter engaging portion 206b is pressed by the container shutter portion-to-be-engaged 214b, so that the main assembly shutter 206 is rotated together with the lever 201 and the container shutter 214 from the open position to the closed position. The supply pack 210 is dismounted from the supplying portion 200 in a state in which the lever 201 is in the first position. In a state in which the supply pack 210 is dismounted from the supplying portion 200, the container shutter 214 is in the closed position, and therefore, toner leakage from the inserting portion opening 212a of the supply pack 210 can be prevented.

### [Controller]

Part (a) of FIG. 15 is a block diagram showing a hardware constitution of the controller 302 provided in the image forming apparatus 1. The controller 302 includes a CPU 302a as a calculating device, the ROM 302b, and a RAM 302c. The CPU 302a reads various programs stored in the ROM 302b and executes processing. The RAM 302c is used as an operation (working) area of the CPU 302a.

To an input side of the controller 302, the switch 208, a temperature sensor 9d, and the remaining amount detecting portion 312 as the remaining toner amount detecting portion are connected. The temperature sensor 9d detects a temperature of the fixing nip of the fixing portion 9. To an output side of the controller 302, the motor 311 as the actuator and a display portion 415 are connected. Further, to the controller 302, an I/O controller 313 as an input/output port connected to the external device is connected.

The motor 311 drives the stirring member 60 and various rollers (the photosensitive drum 11, the developing roller 12, and various conveying rollers) in the image forming apparatus 1. Incidentally, in this embodiment, all the rollers in the image forming apparatus 1 and the stirring member 60 are driven by the single motor 311, but the present invention is not limited thereto. For example, the stirring member 60 and a part of the rollers in the image forming apparatus 1 may be driven by the motor 311, and other rollers may be driven by another motor. Further, a constitution in which the motor 311 is directly connected to all the rollers by drive transmission members such as gears and in which an electromagnetic clutch is provided between the motor 311 and the stirring member 60 may be employed. In this case, an actuator for turning on and off the drive of the stirring member 60 is the electromagnetic clutch.

Part (b) of FIG. 15 is a block diagram showing a functional constitution of the controller 302 provided in the image forming apparatus 1. The controller 302 includes a temperature detecting portion 303, a drive controller 304, a transmitting and receiving portion 305, the remaining amount calculating portion 306, and a storing portion 315. The temperature detecting portion 303 detects a present temperature of the fixing portion 9 on the basis of a temperature detecting signal 307 from a temperature sensor 9d. The drive controller 304 controls drive of the motor 311 as needed on the basis of a print operation, initial control, or the like of the image forming apparatus 1.

A drive enablement discriminating portion 314 discriminates whether or not the motor 311 may be driven, depending on a state of the image forming apparatus 1. For example, the drive enablement discriminating portion 314 does not permit the drive of the motor 311 in the case of a jam state in which the recording material P is stagnated in the image forming apparatus 1 or a state in failure of the image forming apparatus 1, or in the like case. The drive controller 304 drives the motor 311 on the basis of discrimination of the drive enablement discriminating portion 314.

The remaining amount calculating portion 306 calculates an amount of the toner accommodated in the accommodating portion 18, on the basis of a remaining amount detecting signal 309 outputted from the remaining amount detecting portion 312 disposed on the accommodating portion 18. The remaining toner amount discriminated on the basis of an output value of this remaining amount detecting portion 312 is defined as a first remaining amount. In this embodiment, the first remaining amount is a result of discrimination by an optical remaining amount detecting method, and therefore, hereinafter is referred to as optical remaining toner amount. This optical remaining toner amount is stored in the RAM 302c. The transmitting and receiving portion 305 makes transmission and reception of information between itself and the I/O controller 313 for receiving the image information from a host such as a personal computer (not shown). The transmitting and receiving portion 305 transmits remaining amount information 308 to the I/O controller 313.

Here, the remaining toner amount is detected in “%” notation by taking a toner amount necessary for product design as 0% and an amount of the toner capable of being accommodated in the accommodating portion 18 as 100%. Further, although the remaining amount detecting signal 309 varies depending on a constitution of the remaining amount detecting portion 312, the remaining amount detecting signal 309 may be an analog signal such that a voltage changes depending on, for example, a remaining developer amount or may be a pulse signal which is outputted in a certain period and which changes in H/L pulse width depending on the remaining toner amount, for example. In this embodiment, the remaining amount detecting signal 309 outputted from the remaining amount detecting portion 312 is the above-described pulse signal. Further, a Low pulse is outputted when the optical path Q1 (see FIG. 4) of the remaining amount detecting portion 312 is blocked by the toner in the accommodating portion 18, and a High pulse is outputted when the optical path Q1 is not blocked by the toner in the accommodating portion 18. The controller 302 samples the remaining amount detecting signal 309 with an interval of 5 msec and counts the High pulse. The controller 302 measures, as a pulse count, the number of counts of the High pulse outputted when the stirring member 60 rotates one turn. The pulse count as an output value becomes larger with a longer time in which light passes through the optical path Q1, i.e., with a smaller amount of the toner in the accommodating portion 18, and becomes smaller with a longer time in which the optical path Q1 is blocked, i.e., a large amount of the toner in the accommodating portion 18. That is, the controller 302 predicts that the amount of the toner in the accommodating portion 18 is smaller with a larger pulse count and predicts that the amount of the toner in the accommodating portion 18 is larger with a smaller pulse count. The remaining amount calculating portion 306 discriminates the optical remaining toner amount from the pulse count and the aggregation degree threshold table at the time of consumption stored in the ROM 302b when the image forming apparatus 1 is driven by printing or a cleaning sequence or the like of the charging roller 17 (hereinafter, referred to as during toner consumption). The threshold table at the time of consumption is set by empirically acquiring a relationship between the remaining toner amount of the toner in the accommodating portion 18 and the pulse count. Although the relationship between the remaining toner amount and the pulse count changes depending on flowability of the toner, i.e., the pulse count changes due to variation in toner, the threshold table at the time of consumption is set from the relationship between the remaining toner amount and the pulse count for the toner in a design center, and details thereof will be described later.

Further, in the ROM 302b, a pack kind discrimination threshold during supply (hereinafter, also simply referred to as a discrimination threshold) is stored. The pack kind discrimination is set in advance as a threshold for discriminating a kind (classification) of a toner pack in the case where the toner is supplied after the remaining toner amount becomes less than 5%.

After toner supply from the above-described supply pack 210 is completed and movement of the lever 201 from the supply position to the operation position is detected, the remaining amount calculating portion 306 performs supply pack kind discrimination described later from the pulse count and the discrimination threshold. The pack kind discrimination threshold during the supply is acquired empirically, and details thereof will be described later.

Further, the controller 302 calculates a toner consumption amount from pixel information of a printed image and subtracts the toner consumption amount from a toner filling amount at an initial stage, i.e., at the time of a new article (when the supply pack 210 is unused), thus calculating the remaining toner amount. This remaining toner amount calculated from the toner filling amount and the pixel information is defined as a second remaining amount, and is a result of discrimination by the pixel information, and therefore, is hereinafter referred to as a pixel remaining toner amount. The pixel remaining toner amount is stored in the RAM 302c.

### (Optical Remaining Amount Detection Preceding Degree)

Then, when use of the image forming apparatus 1 by the user progresses and the toner is consumed, and first toner supply approaches and eventually the pixel remaining toner amount becomes 10%, the controller 302 calculates an optical remaining amount detection preceding degree by subtracting a value of the optical remaining toner amount from a value of the pixel remaining toner amount (10% in this case). Thus, the controller 302 calculates the optical remaining amount detection preceding degree at a timing when the toner is consumed from the time of the new article (initial stage) and the pixel remaining toner amount becomes 10%. Incidentally, in most cases in this embodiment, when the toner amount of the toner capable of being accommodated in the accommodating portion 18 is taken as 100%, the optical remaining amount detection preceding degree ranges from −5% to +10%. The controller 302 causes the RAM 302c to store the calculated optical remaining amount detection preceding degree. The optical remaining amount detection preceding degree is used in the supply pack kind discrimination described later. In this embodiment, the optical remaining amount detection preceding degree is calculated by the above-described calculation, but the present invention is not limited thereto, and a calculating method of the optical remaining amount detection preceding degree may only be required that the optical remaining toner amount and the pixel remaining toner amount can be compared with each other. For example, a difference between the optical remaining toner amount and the pixel remaining toner amount may be calculated every printing by the image forming apparatus 1 and may be calculated immediately after the movement of the lever 201 to the supply position is detected.

### [Remaining Toner Amount Display]

Next, remaining toner amount display in this embodiment will be described. The display portion 415 is provided, as shown in FIG. 1, on a right side of a front surface of the casing 72 of the image forming apparatus 1 and displays information on the remaining toner amount of the toner in the accommodating portion 18 of the developing container 230.

Parts (a) to (d) of FIG. 16 are enlarged views of the display portion 415. As shown in parts (a) to (d) of FIG. 16, the display portion 415 is constituted so as to be capable of being lighted and extinguished, and is a panel member including a plurality (three in this embodiment) of scales arranged vertically. As shown in part (a) of FIG. 16, in the case where only a lower scale is blinking, the scale shows that a level of the remaining toner amount of the accommodating portion 18 is “NearOut” level. As shown in part (b) of FIG. 16, in the case where only the lower scale is continuously lighted, the scale shows that the level of the remaining toner amount of the accommodating portion 18 is “Low” level. As shown in part (c) of FIG. 16, in the case where the lower scale and a central scale are lighted and an upper scale is extinguished, these scales show that the level of the remaining toner amount of the accommodating portion 18 is “Mid” level. As shown in part (d) of FIG. 16, in the case where all the three scales are lighted, these scales show that the level of the remaining toner amount of the accommodating portion 18 is “Full” level.

Incidentally, the display portion 415 is not limited to a liquid crystal panel, but may be constituted by a light source such as an LED or an incandescent lamp or by a diffusion lens. Further, a constitution in which the display portion 415 is not separately provided and in which a display of the operating portion displays the remaining toner amount by the scales as described above in this embodiment may be employed. Further, although the display portion 415 in this embodiment had the three scales, but the number of scales is not limited thereto, and may be appropriately set depending on a constitution or the like of the image forming apparatus used.

Next, using FIG. 17, switching of the display of the display portion 415 in this embodiment will be described. FIG. 17 is a schematic view for illustrating thresholds for switching display of the display portion 415 depending on a detection result of the remaining toner amount of the accommodating portion 18 of the developing container 230 and for illustrating display patterns of the display portion 415. In the display portion 415, a scale 415a as a first light emitting portion, a scale 415b as a second light emitting portion, and a scale 415c as a third light emitting portion are arranged from below.

As shown in FIG. 17, when the remaining toner amount of the toner in the accommodating portion 18 fluctuates depending on toner consumption or toner supply in an operation in an image forming mode, the controller performs switching of the display of the display portion 415 in the following manner. That is, the controller 302 determines a detection result of the remaining toner amount of the accommodating portion 18 on the basis of the optical remaining toner amount and the pixel remaining toner amount, and performs the switching of the display portion 415 depending on the detection result. Specifically, in the case where the detection result of the remaining toner amount of the accommodating portion 18 is a threshold D (fourth level) or more, the controller 302 causes the display portion 415 to display the Full level at which all the three scales 415a, 415b, and 415c are lighted (first display). Further, in the case where the detection result of the remaining toner amount of the accommodating portion 18 is less than the threshold D and a threshold C (third level) or more, the controller 302 causes the display portion 415 to display the Mid level at which the two scales 415a and 415b are lighted (second display). In this embodiment, a value of the threshold D (fourth level) was set to 25%. Various thresholds including the threshold D described in the following may appropriately be set depending on an amount (capacity) of the toner supplied or depending on various constitutions of the image forming apparatus used.

In the case where the detection result of the remaining toner amount of the accommodating portion 18 is less than the threshold C (third level) (5% in this embodiment) and a threshold B (second level) or more, the controller 302 causes the display portion 415 to display the Low level at which the one scale 415a is lighted (third display). Further, in the case where the detection result of the remaining toner amount of the accommodating portion 18 by the remaining amount detecting portion 312 is less than the threshold B (second level) (0.5% in this embodiment) and a threshold A (first level) or more, the controller 302 causes the display portion 415 to display the NearOut level at which the lower scale 415a is blinking (fourth display). Further, in the case where the detection result of the remaining toner amount of the accommodating portion 18 by the remaining amount detecting portion 312 is less than the threshold A (first level) (0% in this embodiment), the controller 302 discriminates that the toner in the accommodating portion 18 runs out, and puts the three scales in a toner out state in which all the three scales 415a, 415b, and 415c are extinguished.

That is, in the case where the detection result of the remaining toner amount of the accommodating portion 18 by the remaining amount detecting portion 312 is 25% or more, the controller 302 makes the display of the display portion 415 the first display. In the case where the detection result of the remaining toner amount of the accommodating portion 18 by the remaining amount detecting portion 312 is in a range from 5% to 25%, the controller 302 makes the display of the display portion 415 the second display. In the case where the detection result of the remaining toner amount of the accommodating portion 18 by the remaining amount detecting portion 312 is in a range from 0.5% to 5%, the controller 302 makes the display of the display portion the third display. Further, in the case where the detection result of the remaining toner amount of the accommodating portion 18 by the remaining amount detecting portion 312 is in a range from 0% to 0.5%, the controller 302 makes the display of the display portion 415 the fourth display. In the case where the controller 302 discriminated that there is no remaining amount, the controller 302 brings the display portion 415 into a state in which all the scales are extinguished.

The image forming apparatus 1 in this embodiment is capable of supplying the toner by mounting supply packs 210 of various kinds (classifications). For example, a supply pack 210 which is a small pack (hereinafter, simply referred to as the small pack) and a supply pack 210 which is a large pack (hereinafter, simply referred to as the large pack) are mountable to the image forming apparatus 1. The large pack is larger in amount (capacity) of the toner accommodated therein than the small pack. In other words, the small pack as a first container is the supply pack capable of accommodating the toner in a first amount, and the large pack as a second container is the supply pack capable of accommodating the toner in a second amount larger than the first amount.

In this embodiment, in the small pack, toner in an amount corresponding to 25% of the remaining toner amount is accommodated, and in the large pack, toner in an amount corresponding to 50% of the remaining toner amount is accommodated. Accordingly, even when the toner supply is made from a state of less than 25% in remaining toner amount by the supply pack 210 which is either one of the small pack and the large pack, there is a need to switch the display of the display portion 415. Further, the display of the display portion 415 is switched, so that the user is capable of discriminating that the toner supply is completed.

In this embodiment, in the case where the small pack is supplied from a state in which only the scale 415a is lighted or all the scales are extinguished, the remaining toner amount after the supply becomes 25% or more, but the display level is shifted to the Mid level at which the scales 415a and 415b are lighted. On the other hand, in the case where the large pack is supplied from the state in which only the scale 415a is lighted or all the scales are extinguished, the display level is shifted to the Full level at which the scales 415a, 415b, and 415c are lighted. By this specification, the user is capable of discriminating a difference in toner amount between the small pack and the large pack by a change in state of the display portion 415. Accordingly, in the case where the toner is supplied from the state in which only the scale 415a is lighted or all the scales are extinguished, as regards whether to shift a state of the scales to which state, information on whether the toner is supplied from which one of the small pack and the large pack is needed.

Further, in the case where the user supplies the toner is supplied by the small pack from the state in which only the scale 415a is lighted or all the scales are extinguished, in the accommodating portion 18, there is a latitude that toner in a toner amount of 70% or more is accommodated, so that a toner suppliable state is formed. In this embodiment, in the case where the small pack is supplied from the state in which only the scale 415a is lighted or all the scales are extinguished, the display level is shifted to the Mid level at which the scales 415a and 415b are lighted, so that the user is capable of discriminating that the accommodating portion 18 is in the toner suppliable state, and thus user experience is improved.

Incidentally, when the two scales 415a and 415b are lighted, even in the case where the toner is supplied from either one of the large pack and the small pack, a state in which further toner supply is not permitted is formed, and therefore the display level is shifted to the FULL level at which all the scales 415a, 415b, and 415c are lighted. Accordingly, there is no need to discriminate the large pack and the small pack. From the above, in the present invention, when the toner supply is made in a remaining toner amount of 5% or less, the kind of the toner pack is discriminated. Although details will be described later, when fresh (new) toner is supplied from the supply pack, the flowability of the toner in the accommodating portion 18 changes, and therefore, the remaining toner amount after the supply cannot be properly discriminated from the threshold table at the time of consumption and the pulse count. Accordingly, in order to properly performing the switching of the display of the scales, there is a need to discriminate between the large pack and the small pack from the pack discrimination threshold during the supply and the pulse count.

Further, in this embodiment, the display portion 415 is capable of making a supply mode display shown in each of parts (a) and (b) of FIG. 18 separately from the toner supply display described with reference to FIG. 17. The supply mode display is display for causing the user to recognize during execution of an operation in a supply mode. As the supply mode display, a pattern such that a state in which the three scales of the display portion 415 are lighted one by one is repeated as shown in part (a) of FIG. 18, a pattern such that a state in which all the three scales are extinguished and a state in which all the three scales are lighted are repeated as shown in part (b) of FIG. 18, and the like pattern would be considered. The supply mode display is not limited to these specific two patterns, but for example, a pattern such that a state in which the three scales are extinguished one by one from a state in which all the three scales are lighted is repeated, a pattern such that the first display to the fourth display of the display portion 415 described above are randomly switched, and the like pattern would be considered. As the supply mode display, a constitution in which of five states consisting of the first display to the fourth display shown in parts (a) to (d) of FIG. 16, respectively, and an all distinction state (toner out state) in which no scale is lighted, at least two states are repetitively displayed may only be required to be employed. By this, it is possible to make display of a state which is not any one of the above-described five states, so that it is possible to cause the user to visually recognize that the operation in the supply mode is under execution.

### [Flowability of Toner and Optical Remaining Toner Amount]

As described above, the image forming apparatus 1 of this embodiment measures, as the pulse count, a time in which the optical path Q1 (see FIG. 4) in the accommodating portion 18 is not blocked, and then estimates the remaining toner amount of the toner in the accommodating portion 18 on the basis of the measured pulse count. However, the toner in the accommodating portion 18 is different in flowability thereof depending on a use status or the like (hereinafter, this flowability is also referred to as toner flowability) in some cases, and even in the case where the toner amount of the toner in the accommodating portion 18 is the same, the pulse count is different in some instances. That is, when the toner flowability is different, even in the same toner amount, there is a liability that the optical remaining toner amount detected by the remaining amount detecting portion 312 varies. Here, as one index indicating the toner flowability of the toner in the accommodating portion 18, an aggregation degree will be described.

### [Aggregation Degree]

The aggregation degree is an index indicating ease of aggregation (agglomeration) of the toner. In a state in which the aggregation degree is high, toner particles gather and are aggregated, and therefore, the toner flowability lowers. On the other hand, in a state in which the aggregation degree is low, a state in which the toner particles do not readily gather is formed, so that the toner flowability becomes high. Such an aggregation degree can be measured by, for example, the following method.

### (Measurement of Aggregation Degree)

A measuring device for measuring the aggregation degree in order to evaluate flowability of powder is a “Powder Tester (registered trademark) PT-D”, (manufactured by Hosokawa Micron Group). Measurement of the aggregation degree was performed in the following manner. First, on a vibration table of the measuring device, three types of sieves are superimposed and set. The three types of sieves includes a 200-mesh sieve with a sieve mesh of 75 μm, a 390-mesh sieve with a sieve mesh of 38 μm, and a 635-mesh sieve with a sieve mesh of 25 μm, which are disposed in a named order from above. These sieves are set on the vibration table, and 5 g of toner aged overnight in an environment of 23° C. and 50% RH is placed on the uppermost sieve, and then the vibration table is subjected to vibration for 15 sec with an amplitude of 0.6 mm. Then, an amount of the toner remaining on each of the three sieves is measured, and the aggregation degree is calculated by using the following formulas.

$$( Weight of toner remaining on sieve with sieve mesh of 75 μm ) \times 1 \qquad ( a )$$

$$( Weight \% of toner remaining on sieve with sieve mesh of 38 μm ) \times 0.6 \qquad ( b )$$

$$( Weight \% of toner remaining on sieve with sieve mesh of 25 μm ) \times 0.2 \qquad ( c )$$

$$Aggregation degree = ( a ) + ( b ) + ( c ) ( \% )$$

### (Toner Flowability and Remaining Toner Amount Detection)

In the following, a relationship between the toner flowability and remaining toner amount detection will be described. The toner flowability has a tendency to be inversely proportional to the aggregation degree. In the case where the toner flowability is different even when the amount of the toner in the accommodating portion 18 is the same, there is a difference in timing when the toner raised by the stirring member 60 starts to fall down.

In a state in which the toner aggregation degree is low, the toner flowability is high, so that the toner deposited on the stirring member 60 is liable to slip down in a gravitational direction. On the other hand, in a state in which the toner aggregation degree is high, the toner flowability is low, so that when compared with a condition in which the toner flowability is high, there is a tendency that the toner deposited on the stirring member 60 maintains an attitude thereof. For that reason, the toner on the stirring member 60 does not readily slip down in the gravitational direction. That is, a timing when the toner on the stirring member 60 starts to slip down in the gravitational direction becomes slower in a condition in which the toner flowability is low than in the condition in which the toner flowability is high.

For this reason, there is a tendency that a time in which the light receiving portion 312b of the remaining amount detecting portion 312 is capable of detecting the light during rotation of the stirring member 60 through one-full circumference in the condition in which the toner flowability is low becomes longer than in the condition in which the toner flowability is high. That is, even in the case where the amount of the toner in the accommodating portion 18 is the same, when the toner flowability is different, there arises a difference in time when the light receiving portion 312b detects the light. Specifically, a light receiving time of the light receiving portion 312b becomes short in the condition in which the toner flowability is high and becomes long in the condition in which the toner flowability is low. In other words, the pulse count of the remaining amount detecting portion 312 becomes small in a condition in which the in which the toner flowability is high (the toner aggregation degree is low) and becomes large in a condition in which the toner flowability is low (the toner aggregation degree is high). Accordingly, even when the toner amount of the toner in the accommodating portion 18 is the same amount, in the condition in which the toner flowability is high, there is a tendency that the optical remaining toner amount is calculated as a large amount, and in the condition in which the toner flowability is low, there is a tendency that the optical remaining toner amount is calculated as a small amount.

### (Change in Toner Aggregation Degree)

Then, a change in toner aggregation degree will be described. FIG. 20 is a graph showing a relationship between the printed sheet number and the aggregation degree. In the graph of FIG. 20, the abscissa represents the printed sheet number, and the ordinate represents the aggregation degree. In FIG. 20, supply timings from a start of use of the image forming apparatus 1 which has never been used is indicated by vertical broken lines, and the aggregation degree of each of toner different in physical property until the printed sheet number appropriately corresponding to a second supply timing. In FIG. 20, a solid line indicates the aggregation degree of the toner of a design center, a broken line indicates the aggregation degree of the toner of which aggregation degree is hard to increase compared with the design center toner, and a chin line indicates the aggregation degree of the toner of which aggregation degree is easy to increase compared with the design center toner.

As shown in FIG. 20, fresh toner is stably low in aggregation degree irrespective of toner physical properties, but the toner is subjected to mechanical stress, and due to a change in surface abrasion or the like, the aggregation degree gradually increases with an increasing printed sheet number. However, an aggregation degree increasing speed depends on the toner physical properties such as viscoelasticity and the like, and therefore varies. Accordingly, as shown in Figure in the supply timings, the aggregation degree of the toner in the accommodating portion 18 is different depending on the toner physical properties. Further, as shown in FIG. 20, the aggregation degree of the toner of any type converges to a predetermined aggregation degree.

From a characteristic of the above-described change in toner aggregation degree, the threshold table at the time of consumption is set from a relationship, between the remaining toner amount and the pulse count, empirically acquired by using the design center toner. By this, particularly, until first toner supply, a remaining toner amount detection result fluctuates depending on the toner physical properties, but when the printing is continued, the remaining toner amount becomes detectable accurately.

Further, as described above, the fresh toner accommodated in the supply pack 210 has a tendency that the aggregation degree is stably low irrespective of the toner physical property. For this reason, in the case where the remaining toner amount of the toner in the accommodating portion 18 immediately after the toner is supplied from a supply pack 210 which has never been used, there is a tendency that the pulse count of the remaining amount detecting portion 312 becomes low (that the optical remaining toner amount is calculated as a large amount). Accordingly, when the fresh toner is supplied from the supply pack 210, the aggregation degree of the toner in the accommodating portion 18 becomes low compared with the toner aggregation degree before the supply, i.e., the pulse count lowers. For that reason, it is difficult that the pack discrimination threshold at the time of supply is derived from the threshold table at the time of consumption or the like by calculation, and is empirically acquired from a pulse count result when the small pack and the large pack are supplied. Details thereof will be described later.

### [Control of Display Portion in Supplying Operation]

Next, control of the display portion 415 when a supplying operation for supplying the toner from the supply pack 210 to the accommodating portion 18 is performed will be described using a flowchart of FIG. 19.

In a step (hereinafter, referred to as “S”) 41, on the basis of a detection result of the switch 208, the controller 302 discriminates whether or not the lever 201 is in the supplying position. Incidentally, the controller 302 may discriminate that the lever 201 is in the supplying operation on the basis of detection by the open/close detecting portion that the discharge tray 14 is moved from the closed position to the open position, instead of the detection result of the switch 208.

In this embodiment, as described above, the supply pack 210 is mounted to the supplying portion 200 and then the lever 201 is rotated from the operation position to the supply position, so that the toner supply from the supply pack 210 to the accommodating portion 18 becomes possible. In a state in which the lever 201 is in the open position, the user loosens the pouch 211 of the supply pack 210 and thus can supply the toner from the supply pack 210 to the accommodating portion 18. In S41, in the case where the controller 302 discriminated that the lever 201 is not in the supply position, the controller 302 causes the processing to return to S41. In S41, when rotation of the lever 201 from the operation position to the supplying position is detected by the switch 208, the controller 302 causes the processing to go to S42.

In S42, the controller 302 causes the display portion 415 to start supply mode display as described in FIG. 18. When the supply mode display is started, the user performs the supplying operation such that the user loosens the pouch 211 with the user's hands, and thus sends the toner from the pouch 211 of the supply pack 210 toward the accommodating portion 18.

In S43, then the controller 302 discriminates whether or not the lever 201 is in the operation position on the basis of the detection result of the switch 208. That is, the controller 302 discriminates whether or not the lever 201 is moved from the supply position to the operation position. In the case where the controller 302 discriminated in S43 that the lever 201 is not in the operation position, the controller 302 causes the processing to return to S43. In the case where the controller 302 discriminated in S43 that the lever 201 is in the operation position, the controller 302 causes the processing to go to S44.

In S44, the controller 302 discriminates whether or not the motor 311 is drivable. In the case where the controller 302 discriminated in S44 that the motor 311 is not drivable, the controller 302 causes the processing to return to S44. Incidentally, the drive of the motor 311 is stopped between S41 to S43. For this reason, drive noise generating, during the supplying operation performed by the user, from the motor 311, gears for driving the stirring member 60, and the like does not generate, so that the user does not readily hesitate to perform the supplying operation.

In the case where a state in which the print operation can be performed without delay even when the motor 311 is driven is formed, the controller 302 discriminates that the motor 311 is drivable, and in the case where a state in which a jam becomes serious when the motor 311 is driven is formed, or in the like case, the controller 302 discriminates that the motor 311 is undrivable. Further, also in the case where inconveniences occur in the image forming apparatus 1, the controller 302 discriminates that the motor 311 is in an undrivable state. Incidentally, as in this embodiment, in the case where all the rollers in the image forming apparatus 1 and the stirring member 60 are driven by the single motor 311, the processing of S44 is needed, but the present invention is not limited thereto. For example, in the case where rollers relating to conveyance of the recording material are not driven, the processing of S44 is not needed.

In the case where the controller 302 discriminated in S44 that the motor 311 is drivable, the controller 302 causes the processing to go to S45. In S45, the controller 302 starts the drive of the motor 311. By this, the stirring member 60 provided in the accommodating portion 18 is driven. Further, the controller 302 initializes a timer (not shown) and then causes the timer to start. In S46, the controller 302 makes reference to the timer and discriminates whether or not a predetermined time has elapsed from the start of the drive of the motor 311 in S45. In this embodiment, the predetermined time is set to 3 sec. The stirring member 60 smooths the toner in the accommodating portion 18 in 3 sec. This smoothing of the toner in the accommodating portion 18 by the stirring member 60 is executed for preparing for remaining toner amount detection executed in a subsequent step, but may also be omitted.

In the case where the controller 302 discriminated in S46 that the predetermined time has not elapsed, the controller 302 causes the processing to return to S46, and in the case where the controller 302 discriminated in S46 that the predetermined time has elapsed, the controller 302 causes the processing to go to S47. In S47, the controller 302 causes the remaining amount detecting portion 312 to start the remaining toner amount detection of the toner in the accommodating portion 18, and acquires the pulse count (remaining toner amount information) of the remaining amount detecting portion 312 which is remaining amount information after supply. In S48, the controller 302 makes the supply pack kind discrimination.

The supply pack kind discrimination in S48 is made for discriminating the kinds (classifications) of the supply packs 210 different in toner capacity, and in this embodiment, the controller 302 discriminates whether the toner is supplied from either one of the small pack and the large pack described above. The controller 302 compares the pulse count by the remaining amount detecting portion 312 after toner supply and the pack kind discrimination threshold during the supply, and when the pulse count is the discrimination threshold or more, the controller 302 discriminates that the pack kind during the supply is the small pack. On the other hand, when the pulse count is less than the discrimination threshold, the controller 302 discriminates that the pock kind during the supply is the large pack. Incidentally, in this embodiment, the kind of the supply pack (small pack or large pack) is discriminated by using the discrimination threshold, but the present invention is not limited thereto. The controller 302 compares the pulse count by the remaining amount detecting portion 312 after the toner supply and the discrimination threshold, and when the pulse count is the discrimination threshold or more, the controller 302 is also capable of discriminating that the amount of the toner supplied to the accommodating portion 18 during the supply is not less than a certain amount (predetermined amount) corresponding to the discrimination threshold. On the other hand, the controller 302 compares the pulse count by the remaining amount detecting portion 312 after the toner supply and the discrimination threshold, and when the pulse count is less than the discrimination threshold, the controller 302 is also capable of discriminating that the amount of the toner supplied to the accommodating portion 18 during the supply is less than the certain amount corresponding to the discrimination threshold. Further, the controller 302 is also capable of discriminating the pack kind during the supply depending on whether or not the amount of the toner supplied is the certain amount or more. Further, the controller 302 does not discriminate the kind of the supply pack, but may discriminate a supply amount.

Here, details of the pack kind discrimination threshold during the supply will be described. FIG. 21 is a graph in which the abscissa represents the aggregation degree of the toner in the accommodating portion 18 before the supply and the ordinate represents the pulse count after the supply. In the ordinate, an appropriate pack kind discrimination threshold during the supply for the design center toner is indicated by a solid line. Here, “◯” shows supply by the small pack, and “Δ” shows supply by the large pack. Further, in the ordinate, a broken line indicates an appropriate pack kind discrimination threshold during the supply for toner of which aggregation degree is hard to increase compared with the design center T, and a chain line indicates an appropriate pack kind discrimination threshold during the supply for toner of which aggregation degree is easy to increase compared with the design center T.

As shown by “◯” and “Δ” which are indicated by the chain lines in an aggregation degree container in the abscissa of the graph of FIG. 21, when the aggregation degree of the toner in the accommodating portion 18 before the supply is high, there is a tendency that the pulse count after the supply also becomes high compared with the pulse count for the design center toner. On the other hand, as shown by “◯” and “Δ” which are indicated by the broken lines in an aggregation degree container in the abscissa of the graph of FIG. 21, when the aggregation degree of the toner in the accommodating portion 18 before the supply is low, there is a tendency that the pulse count after the supply also becomes low compared with the pulse count for the design center toner. As described above, the aggregation degree of the toner in the accommodating portion 18 during the first supply fluctuates depending on the toner physical property, so that depending on the physical property of the toner in the accommodating portion 18, before the supply the pulse count changes in each of the case where the small pack is supplied and in the case where the large pack is supplied. In other words, depending on the physical property of the toner in the accommodating portion 18 before the supply, the pack kind discrimination becomes difficult in some cases.

For example, a value (Δ in chain line) of the pulse count after the supply in the case where the aggregation degree of the toner in the accommodating portion 18 before the supply is high and the large pack is supplied, and a value (∘ in broken line) of the pulse count after the supply in the case where the aggregation degree of the toner in the accommodating portion 18 before the supply is low and the small pack is supplied approach each other. Accordingly, when a value of the discrimination threshold is fixed irrespective of the aggregation degree, accuracy of the supply pack kind discrimination lowers (risk of erroneous discrimination increases). Further, for example, in the case where the discrimination threshold is fixed to a value corresponding to the design center toner indicated by the solid line, when the aggregation degree of the toner in the accommodating portion 18 before the supply is low, the pack kind cannot be discriminated by the discrimination threshold in which “◯” and “Δ” which are indicated by the broken lines are fixed.

Accordingly, by setting an appropriate pack kind discrimination threshold during the supply corresponding to the toner aggregation degree, it becomes possible to improve discrimination accuracy.

On the other hand, as shown in FIG. 22, in a process in which the toner is consumed by the printing, in the case where the aggregation degree of the toner in the accommodating portion 18 increase, the pulse count becomes high, and therefore, the optical remaining toner amount is discriminated so as to decrease earlier than that of the pulse count toner. In other words, a state in which the toner in the accommodating portion 18 remains in amount larger than the design center toner. Here, in FIG. 22, the abscissa represents an actual remaining toner amount of the toner in the accommodating portion 18, and the ordinate represents the optical remaining toner amount and the pixel remaining toner amount. In the graph of FIG. 22, a solid line shows the pixel remaining toner amount and the optical remaining toner amount of the design center toner, a broken line shows the optical remaining toner amount of the toner of which aggregation degree is hard to increase, and a chain line shows the optical remaining toner amount of which aggregation degree is easy to increase.

As described above, the optical remaining amount detection preceding degree is a value obtained by subtracting a value of the optical remaining toner amount from the pixel remaining toner amount (10% in this case) when the pixel remaining toner amount becomes 10%, but as shown in FIG. 22, when the aggregation degree is liable to increase, the optical remaining amount detection preceding degree takes a positive value. Further, when the aggregation degree of the toner in the accommodating portion 18 does not readily increase the optical remaining amount detection preceding degree takes a negative value. That is, the optical remaining amount detection preceding degree shows ease of an increase in aggregation degree of the toner in the accommodating portion 18, and is a parameter for estimating the aggregation degree of the toner in the accommodating portion 18. Incidentally, in the case of the design center toner, the optical remaining amount detection preceding degree is zero.

From the above, the aggregation degree of the toner in the accommodating portion 18 before the supply is estimated from the optical remaining amount detection preceding degree, and by correcting the pack discrimination threshold during the supply to the appropriate pack discrimination threshold during the supply in the associated aggregation degree shown in FIG. 21, accuracy of the supply pack kind discrimination is improved. In this embodiment, in each of the cases where the optical remaining amount detection preceding degree is −5% or less, 0%, and 10%, the pack kind discrimination threshold during the supply is set, and in the case where the optical remaining amount detection preceding degree is a value between −5% and 10%, the optical remaining amount detection preceding degree is corrected to a value obtained by linear interpolation with an increment of 1%, but a setting method of the optical remaining amount detection preceding degree during the supply is not limited thereto, but the optical remaining amount detection preceding degree during the supply may only be required to be set with necessary and sufficient accuracy. For example, the optical remaining amount detection preceding degree during the supply may be set to two values consisting of 0% or more and less than 0%.

When the optical remaining amount detection preceding degree is expressed by the first remaining amount and the second remaining amount, the optical remaining amount detection preceding degree is obtained by subtracting the first remaining amount from the second remaining amount. Accordingly, the positive optical remaining amount detection preceding degree is the case where the second remaining amount is larger than the first remaining amount, and the negative optical remaining amount detection preceding degree is the case where the second remaining amount is smaller than the first remaining amount.

In the case of the toner of which aggregation degree is easy to increase, by correcting the discrimination threshold so as to become high, a region in which the supply pack is discriminated as the large pack is broadened and a region in which the supply pack is discriminated as the small pack is narrowed. For this reason, in the case where the first remaining amount is smaller than the second remaining amount, it can be said that the discrimination threshold is corrected in a direction in which the kind is discriminated as the kind in which the toner capacity is large among a plurality of kinds. On the other hand, in the case of the toner of which aggregation degree is hard to increase, by correcting the discrimination threshold so as to become low, a region in which the supply pack is discriminated as the large pack is narrowed and a region in which the supply pack is discriminated as the small pack is broadened. For this reason, in the case where the first remaining amount is larger than the second remaining amount, it can be said that the discrimination threshold is corrected in a direction in which the kind is discriminated as the kind in which the toner capacity is small among a plurality of kinds.

Further, a specific value of the pack kind discrimination threshold during the supply was set by empirically acquiring a value capable of properly discriminating the small pack or the large pack from pulse counts when the printing, the small pack supply, and the large pack supply are performed by using toner having various physical properties, including the design center toner.

Then, in second supply and later, as shown in FIG. 20, the aggregation degree of the toner in the accommodating portion 18 sufficiently converges irrespective of the toner physical property, and therefore, even when the pack kind discrimination threshold during the supply is fixed, it is possible to make the supply pack kind discrimination with accuracy.

Returning to FIG. 19, when the supply pack kind discrimination of S48 is ended, in S49, the controller 302 ends the remaining toner amount detection by the remaining amount detecting portion 312. In S50, the controller 302 stops the drive of the motor 311, and stops the rotation of the stirring member 60. Incidentally, the controller 302 may also stop the drive of the motor 311 with an end of the remaining toner amount detection by the remaining amount detecting portion 312.

In S51, the controller 302 switches the display from the supply mode display to the remaining toner amount display, and controls the display portion 415 on the basis of the kind of the supply pack discriminated in the supply pack kind discrimination in S48. For example, in the case where the display portion 415 is in a first state (for example, Low level) before the supplying operation is performed, when the controller 302 discriminated in S48 that the supply pack is the small pack, the controller 302 causes the display portion 415 to be put in a second state (for example, Mid level). Further, in the case where the display portion 415 is in the first state (for example, Low level) before the supplying operation is performed, when the controller 302 discriminated in S48 that the supply pack is the large pack, the controller 302 causes the display portion 415 to be put in a third state (for example, High level). For example, the first state is a state in which of scales of the display portion 415, scale(s) in a first number is (are) lighted, and the second state is a state in which of the scales of the display portion 415, scales in a second number larger than the first number are lighted. Further, the third state is a state in which of the scales of the display portion 415, scales in a third number larger than the second number are lighted. By the above, control of the display portion 415 in the supplying operation is ended.

As described above, to the image forming apparatus 1, one of a plurality of toner containers including a first toner container in which toner in a first toner amount is accommodated and a second toner container in which toner in a second toner amount is accommodated is mountable. Further, the image forming apparatus includes a mounting portion to which the toner container is mountable, an accommodating portion for accommodating the toner supplied from the toner container mounted to the mounting portion, a detecting portion for outputting an output value depending on a remaining toner amount of the toner accommodated in the accommodating portion, and a controller. The controller discriminates whether the toner container used for first toner supply, from an unused state of the accommodating portion, which is toner supply from the toner container to the accommodating portion is the first container or the second container by comparison between a threshold and the output value immediately after the first toner supply is made. Here, a first remaining toner amount is a remaining toner amount of the accommodating portion corresponding to the output value in a predetermined timing before the first toner supply is made. A second remaining toner amount is a remaining toner amount of the accommodating portion based on a toner filling amount of the toner filled in the accommodating portion in the unused state and image information of an image printed from a time of the unused state to the predetermined timing. A first condition is a condition in which the first remaining toner amount is larger than the second remaining toner amount. A second condition is a condition in which the first remaining toner amount is smaller than the second remaining toner amount, The controller sets the threshold so that the toner container used for the first toner supply is easily discriminated as that the toner container is the first toner container in a case where the first condition is satisfied than in a case where the second condition is satisfied. The controller discriminates that the toner operation used for the first toner supply is the first toner container in a case where the output value immediately after the first toner supply is made is higher than the threshold. The controller discriminates that the one toner container used for the first toner supply is the second toner container in a case where the output value immediately after the first toner supply is made is lower than the threshold. The threshold is lower in the case where the first condition is satisfied than in the case where the second condition is satisfied. The first remaining toner amount and the second remaining toner amount are different from each other depending on a value of a difference therebetween. The detecting portion includes a light emitting portion and a light receiving portion for receiving light which is emitted from the light emitting portion and which passed through the accommodating portion. The output value is a value correlating with a time in which the light receiving portion receives the light in a predetermined time.

Further, the image forming apparatus includes a display portion including a plurality of scales for displaying the remaining toner amount of the accommodating portion and constituted so that a number of the plurality of scales displayed or lighted is larger in a case where the remaining toner amount is larger than in a case where the remaining toner amount is small. The controller controls the number of the plurality of scales displayed or lighted by comparison between a threshold and the output value immediately after the first toner supply is made. The controller sets the threshold so that the number of the plurality of scales displayed or lighted is smaller in a case where the first condition is satisfied than in a case where the second condition is satisfied. The controller carries out control so that the number of the plurality of scales displayed or lighted in a case where the output value immediately after the first toner supply is made is higher than the threshold is smaller than in a case where the output value immediately after the first toner supply is made is lower than the threshold.

The above-described plurality of scales include a first scale, a second scale, and a third scale. The predetermined timing is a timing when the first scale is displayed or lighted, and the second scale and the third scale are not displayed or extinguished. The controller causes the second scale to be displayed or lighted and causes the third scale to be extinguished in the case where the output value immediately after the first toner supply is made is higher than the threshold. The controller causes the second scale and the third scale to be displayed or lighted in the case where the output value immediately after the first toner supply is made is lower than the threshold. The third scale, the second scale, and the first scale are arranged downward in a named order in a gravitational direction.

As described above, in this embodiment, by the optical remaining amount detection preceding degree which is a value obtained by comparing the optical remaining toner amount value and the pixel remaining toner amount value, the pack kind discrimination threshold during the supply which is a threshold for discriminating the kind of the supply pack during the supply is set. By this, irrespective of the toner flowability, the small pack and the large pack can be discriminated with accuracy. Further, in this embodiment, in the image forming apparatus to which toner packs of a plurality of kinds different in capacity are mountable, by the optical remaining amount detection preceding degree which is the value obtained by comparing the optical remaining toner amount value and the pixel remaining toner amount value, the pack kind discrimination threshold during the supply which is the threshold for discriminating the kind of the supply pack during the supply was corrected. However, the present invention is not limited thereto. For example, by the optical remaining amount detection preceding degree, a threshold for discriminating whether or not the toner in a certain amount or more is supplied may be corrected, and the optical remaining amount detection preceding degree may be applied to an image forming apparatus to which only a toner pack of a single kind is mountable.

As described above, according to the above-described embodiments, it is possible to discriminate the kind of the toner control with accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-207553 filed on Dec. 8, 2023, which is hereby incorporated by reference herein in its entirety.

What is claimed is:

1. An image forming apparatus to which a plurality of toner containers including a first toner container in which toner in a first toner amount is accommodated and a second toner container in which toner in a second toner amount is accommodated are mountable, the image forming apparatus comprising:
a mounting portion to which one toner container of the plurality of toner containers is mountable;
an accommodating portion configured to accommodate the toner supplied from the one toner container mounted to the mounting portion;
a detecting portion configured to output an output value depending on a remaining toner amount of the toner accommodated in the accommodating portion; and
a controller,
wherein the controller discriminates whether the one toner container used for first toner supply, from an unused state of the accommodating portion, which is toner supply from the one toner container to the accommodating portion is the first toner container or the second toner container by comparison between a threshold and the output value immediately after the first toner supply is made, and
wherein in a case where the remaining toner amount of the accommodating portion corresponding to the output value in a predetermined timing before the first toner supply is made is a first remaining toner amount, the remaining toner amount of the accommodating portion based on a toner filling amount of the toner filled in the accommodating portion in the unused state and image information of an image printed from a time of the unused state to the predetermined timing is a second remaining toner amount, a condition in which the first remaining toner amount is larger than the second remaining toner amount is a first condition, and a condition in which the first remaining toner amount is smaller than the second remaining toner amount is a second condition,
the controller sets the threshold so that the one toner container used for the first toner supply is easily discriminated as that the one toner container is the first toner container in a case where the first condition is satisfied than in a case where the second condition is satisfied.

2. The image forming apparatus according to claim 1, wherein the controller discriminates that the one toner container used for the first toner supply is the first toner container in a case where the output value immediately after the first toner supply is made is higher than the threshold, and discriminates that the one toner container used for the first toner supply is the second toner container in a case where the output value immediately after the first toner supply is made is lower than the threshold, and
wherein the threshold is lower in the case where the first condition is satisfied than in the case where the second condition is satisfied.

3. The image forming apparatus according to claim 1, wherein the threshold is different depending on a value of a difference between the first remaining toner amount and the second remaining toner amount.

4. The image forming apparatus according to claim 1, wherein the detecting portion includes a light emitting portion and a light receiving portion for receiving light which is emitted from the light emitting portion and which passed through the accommodating portion, and
wherein the output value is a value correlating with a time in which the light receiving portion receives the light in a predetermined time.

5. An image forming apparatus to which a toner container is mountable, the image forming apparatus comprising:
a mounting portion to which the toner container is mountable;
an accommodating portion configured to accommodate toner supplied from the toner container mounted to the mounting portion;
a detecting portion configured to output an output value depending on a remaining toner amount of the toner accommodated in the accommodating portion;
a display portion including a plurality of scales for displaying the remaining toner amount of the accommodating portion and configured so that a number of the plurality of scales displayed or lighted is larger in a case where the remaining toner amount is large than in a case where the remaining toner amount is small; and
a controller,
wherein the controller controls the number of the plurality of scales displayed or lighted by comparison between a threshold and the output value immediately after first toner supply, from an unused state of the accommodating portion, which is toner supply from the toner container to the accommodating portion is made, and
wherein in a case where the remaining toner amount of the accommodating portion corresponding to the output value of the detecting portion in a predetermined timing before the first toner supply is made is a first remaining toner amount, the remaining toner amount of the accommodating portion based on a toner filling amount of the toner filled in the accommodating portion in the unused state and image information of an image printed from a time of the unused state to the predetermined timing is a second remaining toner amount, a condition in which the first remaining toner amount is larger than the second remaining toner amount is a first condition, and a condition which the first remaining toner amount is smaller than the second remaining toner amount is a second condition,
the controller sets the threshold so that the number of the plurality of scales displayed or lighted is smaller in a case where the first condition is satisfied than in a case where the second condition is satisfied.

6. The image forming apparatus according to claim 5, wherein the controller carries out control so that the number of the plurality of scales displayed or lighted in a case where the output value immediately after the first toner supply is made is higher than the threshold is smaller than in a case where the output value immediately after the first toner supply is made is lower than the threshold, and
wherein the threshold is lower in the case where the first condition is satisfied than in the case where the second condition is satisfied.

7. The image forming apparatus according to claim 6, wherein the plurality of scales include a first scale, a second scale, and a third scale,
wherein the predetermined timing is a timing when the first scale is displayed or lighted, and the second scale and the third scale are not displayed or extinguished, and
wherein the controller causes the second scale to be displayed or lighted and causes the third scale to be extinguished in the case where the output value immediately after the first toner supply is made is higher than the threshold, and causes the second scale and the third scale to be displayed or lighted in the case where the output value immediately after the first toner supply is made is lower than the threshold.

8. The image forming apparatus according to claim 7, wherein the third scale, the second scale, and the first scale are arranged downward in a named order in a gravitational direction.
